(19) United States
(12) Patent Application Publication
(10) Pub. No.: US 2011/0275441 A1
(43) Pub. Date: Nov. 10, 2011

(54) PORTABLE REAL ESTATE SOCIAL GAME AND INFORMATION SHARING SYSTEM

(76) Inventor: Brian Wilson, The Woodlands, TX (US)

(21) Appl. No.: 12/856,670

(22) Filed: Aug. 15, 2010

Related U.S. Application Data
(60) Provisional application No. 61/332,792, filed on May 9, 2010.

(51) Int. Cl. G06F 17/00

(52) U.S. Cl. 463/42

(57) ABSTRACT

A method, apparatus, and computer readable storage to implement an interactive social gaming environment relating to real estate purchasing. Users (or players) of the system can access valuable Realtor Multiple Listing System (MLS) information as well as additional player-generated information on cities, neighborhoods, and homes for sale. In this manner, information about homes and neighborhoods that is not otherwise available and that is sometimes unfavorable can be made transparent by and for potential home buyers, informed neighbors, real estate agents, and other home owners considering the sale of their home. This creates a new level of transparency of real estate information that benefits all interested parties. Players can also see otherwise unavailable information on the interest level of other players into neighborhoods and homes based on the real-time aggregation and public display of player check-ins. This game utilizes this activity information to assign players as rivals whose activities suggest they have similar neighborhood or home interests.

This Application claims benefit to U.S. provisional application 61/332,792, entitled, “Portable Real Estate Social Game and Information Sharing System” filed in the USPTO on May 9, 2010, which is incorporated by reference herein in its entirety for all purposes.

### BACKGROUND OF THE INVENTION

1. Field of the Invention

The present general inventive concept is directed to a method, apparatus, and computer readable storage medium directed to a portable real estate tracking system

2. Description of the Related Art

Bloomberg, U.S. Pat. No. 6,385,541, teaches a system that uses a locating means such as GPS to pinpoint a location of a wireless device. Once the location is ascertained, a nearby home for sale can be identified and information about the home can be transmitted to a user of the wireless device. Such a device can assist users in obtaining information from sellers about houses for sale that they are near.

Database systems are used so that a seller or his agent can list information about their house and interested persons can retrieve the information about houses they are interested in. One disadvantage to these database systems and locating devices is that they are geared to disseminating information only from the sellers to the buyers. There is currently no direct communication or information channel for buyers and sellers to engage directly before the offer/counteroffer/accept stage. All communication is restricted to agent intermediaries.

However, what is needed is a system that utilizes these databases and locating devices of house-hunters in order to encourage and facilitate the dissemination of information between house-hunters, sellers, informed neighbors, and agents.

In addition, there is a large amount of information that home owners could find very valuable about the pricing and positioning of their home that is not being collected by any source and therefore not available. Every time that a home buyer stops in front a home for a curbside showing, or previews the home's neighborhood this adds to the aggregate, yet undisclosed, level of interest in the home. Additionally, each time a home buyer returns for a second or third time to view the same house from the exterior or to re-tour the neighborhood, even more valuable information about specific information is aggregated, yet uncollected and not disseminated.

What is needed is a system that collects, aggregates and disseminates this home buyer activity so that home owners can gauge the level of interest in their home or neighborhood both absolutely and relative to other homes and neighborhoods that may be competitive. The collection and transparency of this information would be critical to home owner's pricing and marketing strategy, and also critical to home buyers who can better understand the necessitated urgency to act on a specific home.

In addition, the current MLS system creates a level of transparency between real estate agents only. Public websites that display MLS information only show the information permitted by the Realtor MLS Association which is filtered and restricted prior to public release.

What is also needed is a system that enables the public access to the additional MLS information available online that is only available through Realtors who are members of the MLS Association plus more information provided by people who have seen, evaluated, and left feedback about cities, neighborhoods, and homes based on their visits and showings.

Finally, due to the inaccessibility by home buyers and sellers of direct access to the critical important home and neighborhood information, home buyers and sellers are required to make a professional and sometimes legal commitment to a real estate agent in order to access this information during their information gathering phases. In many cases home buyers and sellers are not prepared to make this type of commitment but not accessing the critical information is not an alternative. This limits the home buyer and home seller's freedom to due diligence before making a financial commitment to a real estate agent.

What is also needed is a system that allows home buyers and home sellers to access this critical information still through the sponsorship of a real estate agent but in a manner that does not require premature commitments. It affords the home buyer and home seller the liberty to conduct due diligence into homes and neighborhoods because they have the critical housing information that was previously not available to them without first making a commitment to a real estate agent. Once the home owner or home buyer is comfortable with their independent due diligence then they can make a more informed decision on the real estate agent that they would like to engage based on information like agent activity, agent responsiveness and professionalism, and agent productivity in the specific neighborhoods the home buyer or seller has researched. From the real estate agent perspective, this system is a new way to provide automated and deliberate valuable information about homes and neighborhoods to a potential client in a non-committal, non-threatening manner that has the potential to develop into an agent-client relationship. This could result in a new source of business for real estate agents.

### SUMMARY OF THE INVENTION

It is an aspect of the present invention to provide for improving exchanges of real estate information.

The above aspects can be obtained by (a) executing instructions on a processor running on a portable computing device to perform the following operations: (b) registering a first player in a remote database; (c) physically visiting a house by the first player; (d) checking in to the house by the first player; and (e) determining and displaying to the player a list of rivals, the list comprising other players that have checked in to the house at least once.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating prior art transfer of real estate information;

FIG. 2 is a block diagram illustrating a secondary market of real estate information, according to an embodiment;

FIG. 3 is an exemplary flowchart illustrating a method of distributing home information, according to an embodiment;

FIG. 4 is an exemplary flowchart illustrating a method of sharing home information between house-hunters, according to an embodiment;

FIG. 5 is an exemplary flowchart illustrating a method of checking into cities and neighborhoods, according to an embodiment;

FIG. 6 is an exemplary flowchart illustrating a method of manual home check in, according to an embodiment;

FIG. 7A is an exemplary flowchart illustrating a method of manual neighborhood check in, according to an embodiment;

FIG. 7B is an exemplary flowchart illustrating a method of manual city check in, according to an embodiment;

FIG. 8A is an exemplary flowchart illustrating a dataflow of how a player can access information from the system, according to an embodiment;

FIG. 8B is an exemplary flowchart illustrating a method of generating target neighborhoods and homes, according to an embodiment;

FIG. 8C is an exemplary flowchart illustrating a method of displaying homes using a color key, according to an embodiment;

FIG. 9 is a drawing of a portable device showing a main menu, according to an embodiment;

FIG. 10 is a drawing of a portable device showing an informational menu, according to an embodiment;

FIG. 11 is drawing of a portable device showing a city menu, according to an embodiment;

FIG. 12 is a drawing of a portable device showing a check in screen, according to an embodiment;

FIG. 13 is a drawing of a portable device showing a home menu, according to an embodiment;

FIG. 14 is a block diagram of components of a network that can be used to implement the methods described herein;

FIG. 15 is a block diagram of a portable electronic device that can be used to implement the methods described herein;

FIG. 16A is a flowchart illustrating a method of displaying a player's rivals, according to an embodiment;

FIG. 16B is a drawing of a portable device showing list of players currently checked in to the player's location, according to an embodiment;

FIG. 17 is a drawing of a first set of output screens on a mobile device, according to an embodiment;

FIG. 18 is a drawing of a second set of output screens on a mobile device, according to an embodiment;

FIG. 19 is a drawing of a third set of output screens on a mobile device, according to an embodiment;

FIG. 20 is a drawing of a fourth set of output screens on a mobile device, according to an embodiment;

FIG. 21 is a drawing of a fifth set of output screens on a mobile device, according to an embodiment;

FIG. 22 is a drawing of a sixth set of output screens on a mobile device, according to an embodiment;

FIG. 23 is a drawing of a seventh set of output screens on a mobile device, according to an embodiment;

FIG. 24 is a drawing of an eighth set of output screens on a mobile device, according to an embodiment;

FIG. 25 is a drawing of a ninth set of output screens on a mobile device, according to an embodiment;

FIG. 26 is a drawing of a tenth set of output screens on a mobile device, according to an embodiment;

FIG. 27 is a drawing of an eleventh set of output screens on a mobile device, according to an embodiment;

FIG. 28 is a drawing of a twelfth set of output screens on a mobile device, according to an embodiment;

FIG. 29 is a drawing of a thirteenth set of output screens on a mobile device, according to an embodiment;

FIG. 30 is a drawing of a fourteenth set of output screens on a mobile device, according to an embodiment;

FIG. 31 is a drawing of a fifteenth set of output screens on a mobile device, according to an embodiment;

FIG. 32 is a drawing of a sixteenth set of output screens on a mobile device, according to an embodiment;

FIG. 33 is a drawing of a seventeenth set of output screens on a mobile device, according to an embodiment;

FIG. 34 is a drawing of an eighteenth set of output screens on a mobile device, according to an embodiment;

FIG. 35 is a drawing of a nineteenth set of output screens on a mobile device, according to an embodiment;

FIG. 36 is a drawing of a twentieth set of output screens on a mobile device, according to an embodiment;

FIG. 37 is a drawing of a twenty-first set of output screens on a mobile device, according to an embodiment;

FIG. 38 is a drawing of a twenty-second set of output screens on a mobile device, according to an embodiment;

FIG. 39 is a drawing of a twenty-third set of output screens on a mobile device, according to an embodiment;

FIG. 40 is a drawing of a twenty-fourth set of output screens on a mobile device, according to an embodiment;

FIG. 41 is a drawing of a twenty-fifth set of output screens on a mobile device, according to an embodiment;

FIG. 42 is a drawing of a twenty-sixth set of output screens on a mobile device, according to an embodiment;

FIG. 43 is a drawing of a twenty-seventh set of output screens on a mobile device, according to an embodiment;

FIG. 44 is a drawing of a twenty-eighth set of output screens on a mobile device, according to an embodiment;

FIG. 45 is a drawing of a twenty-ninth set of output screens on a mobile device, according to an embodiment;

FIG. 46 is a drawing of a thirtieth set of output screens on a mobile device, according to an embodiment;

FIG. 47 is a drawing of a thirty-first set of output screens on a mobile device, according to an embodiment; and

FIG. 48 is a drawing of a thirty-second set of output screens on a mobile device, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement an application that can run on a personal computing device such as a PDA or a mobile phone. The application is designed to encourage communication between parties looking to purchase, sell, rent and casually research and explore cities, neighborhoods, and homes for sale or rent. The methods described herein can be embodied on an application that can be downloaded and executed on a portable device, or alternatively can be implemented entirely (or in part) on the World Wide Web using the portable device's web browser.

The exchange of information amongst these interested parties fills an important gap that the above systems do not provide and would help everyone find out more authentic, unfiltered information about local homes, neighborhoods, and cities. All parties including sellers benefit from this transparency of information. As a large amount of information exchanged about a particular home can serve as market feedback to sellers that currently is invisible to them. The only current indicators they can use to gauge market feedback on pricing, condition, and market positioning is the number of showings, and agent feedback on the showings and ultimately the number and nature of offers on their home. This information also exists about their neighborhood but is invisible and not aggregated at the neighborhood level even though the market activity and interest in a neighborhood has a direct impact on the market value of the homes in that neighborhood. Transparency into the aggregate level of interest into one's neighborhood is a pricing factor. This information can benefit all interested parties and is only available through a new framework of social interactions using technology that aggregates and shares the opt-in participation of people and the “wisdom of the crowd.”

The inventive concepts described herein also provide a new way for agents to interact with existing clients. Currently, agents can interact in person, over the phone, over email, over text messages, over social networking sites but there is no social game environment where agents can interact with clients. By using this invention's tools to provide information to one's clients and communicate with them in this manner and interact with them within a social game framework, the invention promotes increased and more productive interaction between agent and client through a point and rank system that encourages favorable behavior by clients.

In addition, the inventive concepts described herein provide a way for sellers and landlords to have more information about the level of interest in their home from house hunters. When a player in the system described herein checks into a home from the curb the owner of the home or his or her agent can see that activity by the player and it is added to the aggregate activity of the other players who checked in to the home. The seller or his or her agent also has the option to interact with the house hunter directly through the game channel by sending a private message that can be used to send a message to the anonymous player to encourage them to view the home or even offer a private incentive to encourage further interest or an offer. Sellers and their agents will also have access to the feedback left by players who have checked in to the home and leaving “curbside” feedback that provides more information to the seller and his agent about the market's reaction to the home's condition and pricing that would not otherwise be collected and shared.

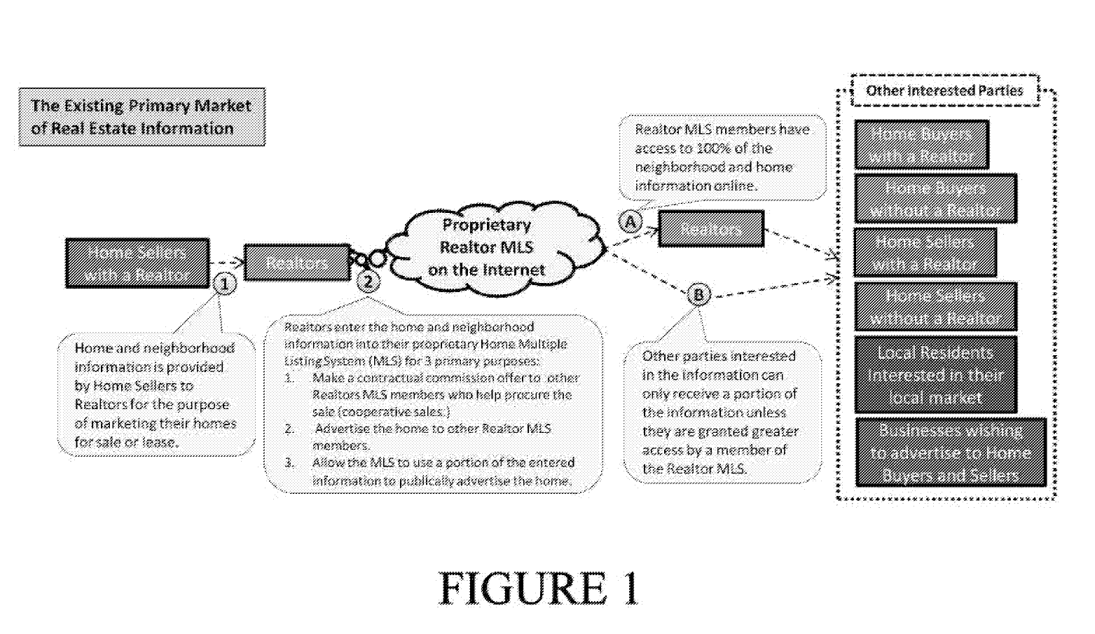

FIG. 1 is a block diagram illustrating prior art transfer of real estate information.

The typical flow of information is as follows. A home seller contracts with a Realtor to market his or her home for sale or rent. The realtor enters the home and neighborhood information into a propriety Home Multiple Listing System (MLS) database thus listing the home as “for sale” or “for rent.” The MLS distributes information about the home listing to other realtors, who then distribute the information to interested parties such as home buyers. Or a limited and filtered set of the home information is distributed on the World Wide Web on the MLS or member Realtor web sites.

One drawback of the above paradigm is there are limited opportunities for interested parties to exchange information with each other since the best information about a city's home for sale is in the Realtor MLS and access to this information is strictly restricted from public use and available only through a MLS member's permission.

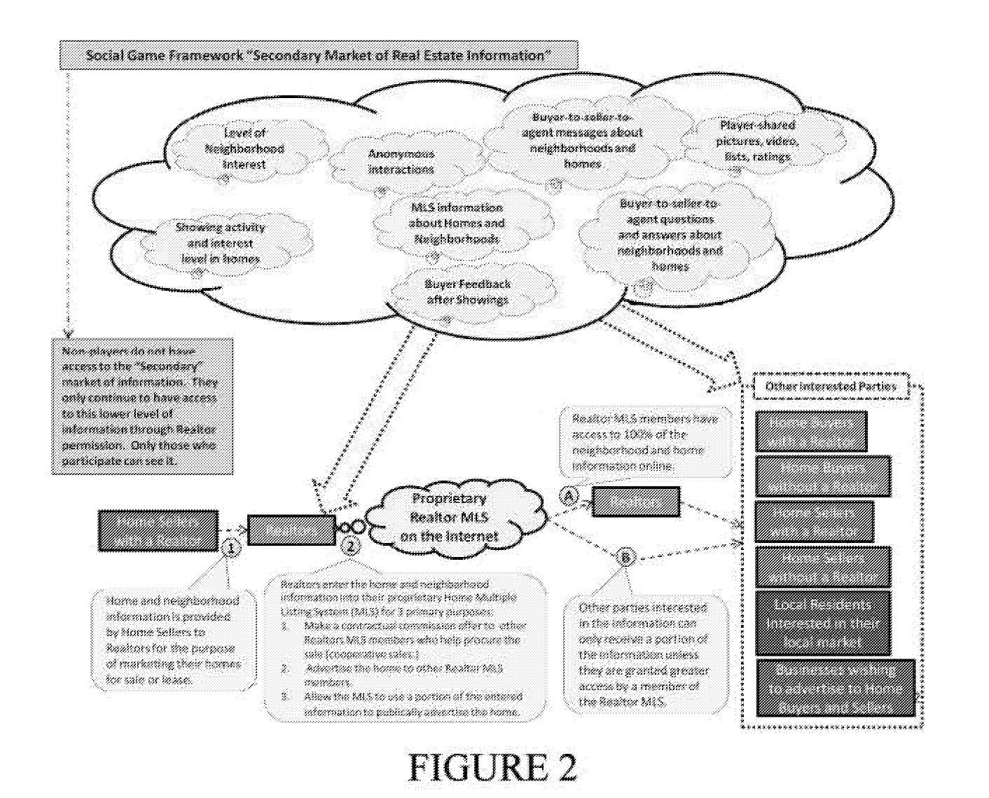

FIG. 2 is a block diagram illustrating a secondary market of real estate information according to an embodiment.

While the paradigm illustrated in FIG. 1 is generally applied, the secondary market augments this paradigm by providing an avenue for interested parties and realtors to exchange information in addition to the information stored in the MLS database. This includes the information created when a home is shown or a neighborhood is driven by prospective house hunters. The first-person feedback resulting from these activities include written feedback, pictures, questions and answers, videos, extra incentives, etc. and is captured, aggregated, and disseminated publicly for the first time through the framework of the game. This additional layer of information created and disseminated about neighborhoods and homes becomes a secondary market of information since it is only accessible to other players who participate in the game. Thus it is a market where players participate in a “give and take” of valuable and otherwise unavailable, information. All of this information can be stored and accessed using cellular phones (or personal computers) which can transmit information to an associated web site/server which stores the secondary market information.

By allowing home buyers, home sellers, real estate agents, and interested local parties to share information with each other, the home buyers will gain more situational awareness about the neighborhoods and homes they are interested in and thus will feel secure that they can make an informed purchase or rent. This should increase the sales of homes in general and fairly influence home pricing since house-hunters will have more information at their disposal to make an informed decision. Currently home pricing is based on recent comparable sales but this new secondary market of information based on real-time house-hunter activity and feedback provides additional authentic information that is highly-relevant to home pricing. In addition to sharing information about homes for sale, buyers can also share information about other relevant matters, such as productivity and professional of individual realtors (e.g., their trustworthiness, responsiveness, etc.), neighborhood facts and options, city feedback, etc.

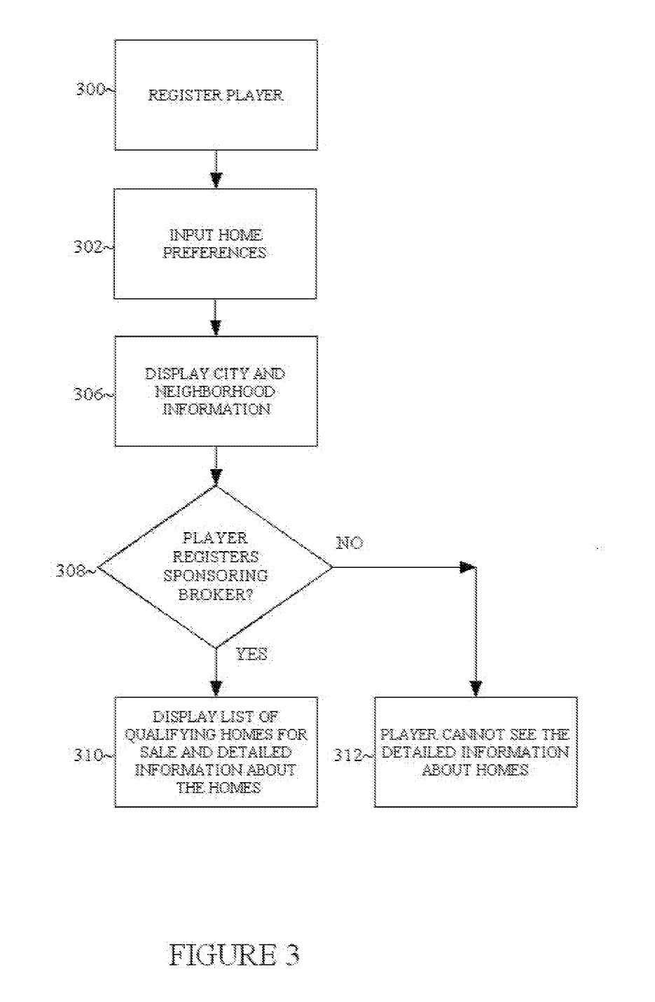

FIG. 3 is an exemplary flowchart illustrating a method of distributing home information, according to an embodiment.

The method can begin with operation 300, which registers a player (or user) with the system. This can be done as known in the art. For example, the player enters a game, and inputs a user-name, a password, email address, selects a game avatar, and enters home preferences. In one embodiment personal identifying information (such as the player's real name, address, does not have to be entered). In an alternate embodiment, such identifying information would be required.

From operation 300, the method can proceed to operation 302, which inputs from the player the player's home preferences (e.g., price range, location, size, etc.) The home preferences can be stored in the player's account (or more precisely a record associated with the player's account) although the preferences can be changed at any time by the player. It is noted that cities can be predefined by known mapping standards (ranges of coordinates). Neighborhood boundaries are more subjective, and thus neighborhoods are drawn on an online map by players and moderated by the player community. This uniquely defines the geographical boundaries of the neighborhoods in the game.

From operation 302, the method can proceed to operation 306, which displays any city and neighborhood information to the player that the player requests. City information can be any demographic information relating to a city, such as average income, crime rates, etc. Neighborhood information can be any demographic information relating to a neighborhood, such as average income, average home values, crime rates, school ratings, etc.

From operation 306, the method proceeds to operation 308, which determines whether the player chooses to register, however registering in the system would not automatically create a client-agent relationship. Once registered (or affiliated) with the system, this would typically satisfy the Realtor MLS prerequisite that to access the database it must be through a member agent. In order to take full advantage of the system, a player would typically be required to select a participating real estate broker. If the player does not select a participating real estate broker, then the method proceeds to operation 112, wherein the player cannot see this additional, MLS-provided information about homes or home sale statistical information aggregated and offered at the neighborhood level.

If in operation 308, it is determined that the player has selected a participating broker, then the method proceeds to operation 310, which allows the player to see detailed information about individual homes. The detailed information is the information about the home provided by the Realtor MLS such as square footage, pictures, seller description, room dimensions, etc. In operation 310, the system (application) can also display a list of qualifying homes that meet the player's home preferences (criteria) entered in operation 302. Once registered with a broker, then player can also see information/feedback left on the system by other players.

Once a player is a registered player, then the player can take advantage of receiving information from the application/system. The player's portable device would typically have some type of method for locating its physical location (e.g., triangulation, using GPS, etc.) The application can then automatically use this information in order to track the player's activity as well as to provide the player with information. When the player physically steps into a city and then a neighborhood, the application can detect the player's presence and query the player whether the player wishes to “check in” to that city, neighborhood, or individual house for sale. For privacy concerns or game strategy reasons, the player may not wish to always check into locations he is present in. However, by checking in, the player then gets access to the information about the home or neighborhood or city that is only available to players who opt check in. Thus there is a choice to anonymously disclose one's interest in a city, neighborhood, or home (thereby showing the sellers in the area there is more interest) in exchange for the valuable information added by other players and earning game points and achievements.

One of the features of the methods described herein is that the application can be used by multiple house-hunters and thus information can be shared between house-hunters as well as local neighbors. This sharing of information can result in information being shared by an informed neighbor that the sellers (and realtors) would not want the house-hunters to know (e.g., damage, latent problems, crazy neighbors, etc.), with the ultimate advantage for all participating in the housing market being increased transparency.

If in operation 308, it is determined that the player did not register with a broke, then operation 312 is invoked wherein the player cannot see information about the homes for sale or rent provided by the MLS or from feedback and content provided by the other players.

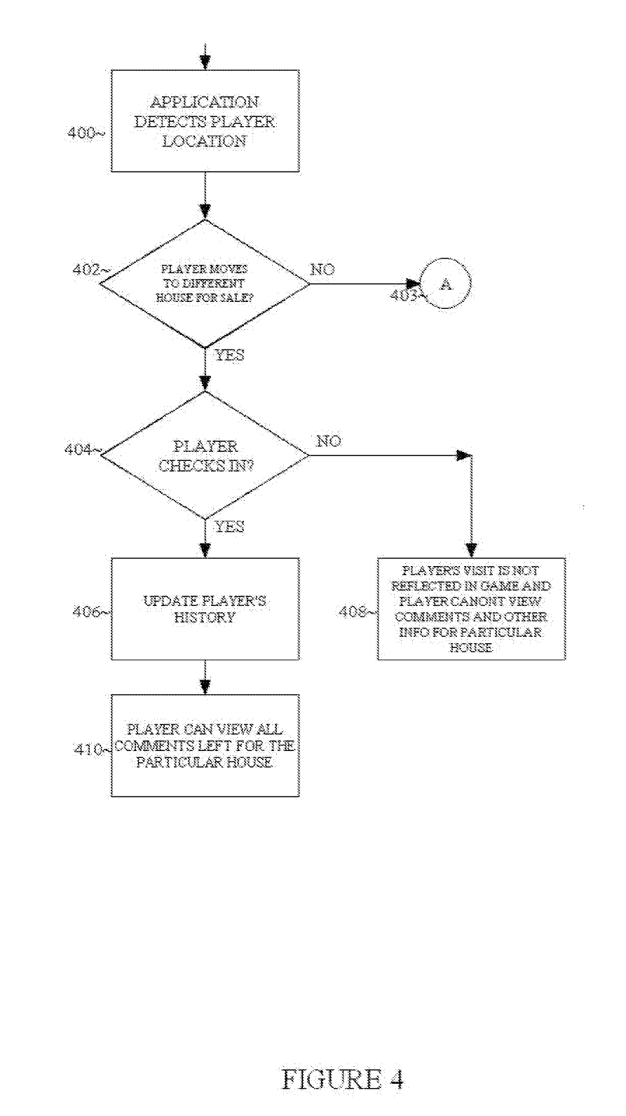

FIG. 4 is an exemplary flowchart illustrating a method of sharing home information between house-hunters, according to an embodiment.

The method can begin with operation 400, wherein the application detects a physical location of the player. The application can continuously be running and when it senses a change in physical location, it can determine (through coordinate of where the device the application is running in is). The device's location (and hence presumably the location of the player) can be detected using any known location detection mechanism (see U.S. Pat. No. 6,385,541, which is incorporated by reference herein in its entirety). The location can be returned in terms of coordinates, which can then be used to determine the player's location and thus whether the player falls inside a zone defining a city, neighborhood, or house.

From operation 400, the method proceeds to operation 402, which determines whether the player has physically moved his or her location to a different house for sale (than one where the player may have been present already for a predetermined period of time) while carrying the mobile device running the mobile application described herein. When the player is visiting a house for sale, the application auto-detects the player's presence at a house for sale and will give the player a chance to check into that house. The physical location of the player would typically have to be very close to the coordinates of the house for sale (so that if the player is merely driving by and not stopping in front of houses for sale, it will not trigger going to operation 404). The application suggests which home the player is closest to but also provides a list of nearby homes to instead check into just in case. As another check to make sure the player is not merely driving by a home for sale, a check may be performed to ensure that the player is physically located at the house for sale for at least a predetermined period of time (e.g., 15 seconds or other amount of time).

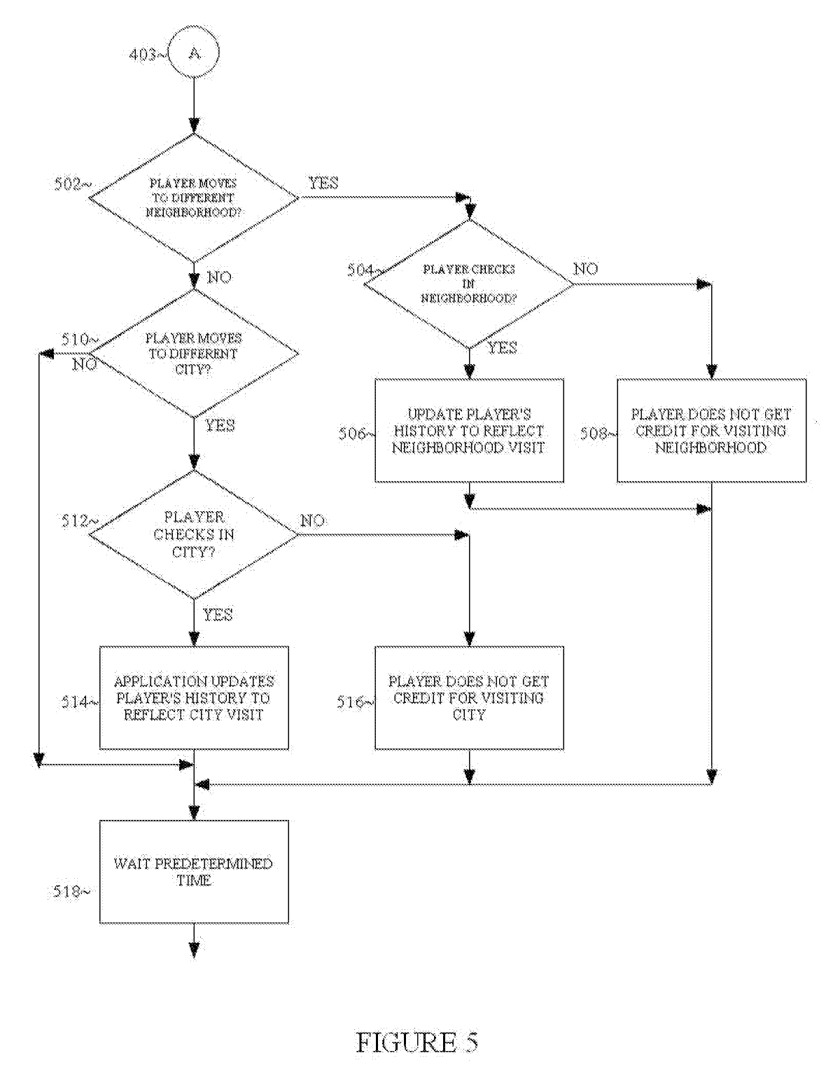

If in operation 402, it is determined that the player has not moved to a different house for sale (e.g., did not arrive at a house for sale), then the method proceeds to connector 403 which continues the method on FIG. 5.

If in operation 402, it is determined that the player did arrive at a house for sale, then the method proceeds to operation 404, wherein a manual check-in screen is displayed on the player's portable device running the application. The check-in screen can be a pop-up window which outputs a message such as, “do you wish to check into this house” and may identify the house by address and/or picture. If the player does not wish to check into the house, then the player can press a “no” button on the display and the method proceeds to operation 408, wherein the player's visit is not reflected in the game (e.g., the player's history is not updated to include this house being visit). The consequence is that the player does not get to see the extensive game information and MLS information about the home. The player would not get to see the unique information and feedback left for this house by other players. Other players would not know that the player has visited this particular house. The method can then proceed to operation 518 (not pictured in FIG. 4).

If in operation 404, it is determined that the player did check into the home (by pressing a button that says “yes” or “check-in”), then the method proceeds to operation 406, which updates the player's history in the application. The player's history is actually stored on a remote server (not the actual device running the application) that the application has access to. Since the player has checked in to a new home for sale, the system can also award the player point(s) for visiting a home for sale. Typically, players will not get additional points for checking into a home for sale more than once. Once checked in the player gets full access to all the information added about the home from the following sources: the Realtor MLS information; curbside feedback from other players; interior showing feedback from other players; player added media including pictures and video; seller or seller's agent added special information like additional pictures, videos; incentives offered on the home by the owner or agent to only payers in the game; and home sponsor information and incentives like a free appraisal or home inspection. The player also has the opportunity to offer his own feedback, pictures, ratings, questions or answers, or contact the agent or owner anonymously directly, all of which earn game points and achievements and all of which are only possible upon checking in and upon providing feedback and content about the home back to the game. In operation 406, all other players that are also checked in to this house can now see that the player has checked in to this house.

From operation 406, the method proceeds to operation 410, wherein the player has the option to leave comments about the home for sale he or she is currently visiting. Comments can be anything about the home, such as its condition, neighbors, grounds, noise, etc. Comments would typically be visible by all players who check into the same house. Comments may also be visible to the owner (seller) of the house and the seller's broker, and those parties may have the opportunity to post replies to such comments which are also visible to all people who can view the comments. Players can also view all feedback and content left by other players this particular house. The method can then proceed to operation 518.

If in operation 410, the player decides to leave comments, then the player can type in their comments about the house which will be stored on the remote server and made publicly available to other players who check into this home. Once a player checks into a home, he may return at a later time to view any additional comments that other players may have posted about this home (without having to physically return to the house). However, each time the player recalls the home on their device, it will be counted as a check in to indicate the player's level of interest in the home. The method can also proceed to operation 518.

FIG. 5 is an exemplary flowchart illustrating a method of checking into cities and neighborhoods, according to an embodiment. FIG. 5 is a continuation of the method illustrated in FIG. 4.

FIG. 5 begins with connector 403 (from FIG. 4), which proceeds to operation 502, which determines whether the player has physically changes his or her location to a different neighborhood (as with all of these determinations the player must of course be carrying the mobile device). If the player visits a neighborhood or city that he has already checked in to, the player can check in again. This can be determined by comparing of the location of the player (device) changes into a different neighborhood zone (neighborhood and city zones can be a range of physical coordinates). If the player stays in the same neighborhood this would not count. If the player has moved his or her location to a different neighborhood, then the method proceeds to operation 504, wherein the player is presented with a check in prompt on the player's portable device (e.g., a pop-up window asking, “do you wish to check into the neighborhood of Glen Oaks?”) If the player selects “no” (e.g., presses a “no” button on the display), then the method proceeds to operation 508, wherein the player does not get credit for visiting the neighborhood the player is currently present in. Thus, the player cannot see the feedback and content left by other players about this neighborhood and the player does not get game credit for exploring this neighborhood. The method can then proceed to operation 518.

If in operation 504, the player decides to check into the neighborhood (e.g., by pressing a “yes” button on the display), then the method proceeds to operation 506, which updates the player's history to reflect the player's neighborhood visit. Once checked in, it opens all information about the neighborhood to the player and additional interaction options. It is also disclosed to the other players that are also checked in to this neighborhood that the player has checked in to this neighborhood. The method can then proceed to operation 518.

If in operation 502, the method determines that the player has not moved to a different neighborhood, then the method proceeds to operation 510, which determines if the player has physically moved to a different city. This can be done in the same manner in operation 502, however the range for the city coordinates would typically be much larger than the range of coordinates for a neighborhood. If the player has not moved his or her location to a different city, then the method can proceed to operation 518.

If the player has moved his or her location to a different city, then the method can proceed to operation 512, which determines if the player manually checks into the city. The player will be presented on his or her portable device with a pop-up window asking the player to select whether the player wants to check in or not. If the player decides not to check into the city (by pressing/touching a “no” button), then the method proceeds to operation 516, wherein the player does not get credit for visiting the city. The player cannot see the feedback and content left by the other players about this city and the player does not get game credit for exploring this city. The method can then proceed to operation 518.

If in operation 512, it is determined that the player decides to check into the city (e.g., by pressing/touching a “yes” or “check-in” button in the device), then the method proceeds to operation 514, wherein the application updates the player's history to reflect the player's visit to the city. When a player checks into a city, it opens up additional information about the city to the player and provides additional interaction options. It is disclosed to all other players that are also checked in to this city that the player has checked in. From operation 514, the method proceeds to operation 518.

In operation 518, the application can wait a predetermined amount of time (e.g., 5 minutes, etc.) before returning to operation 400 to detect the player's location again. Waiting the predetermined amount of time may save processing resources and battery life.

It is noted the operations in FIGS. 4-5 (and other Figures as well) are intended to be a high level “pseudo-code” example of the present inventive concepts in order to help illustrate the concepts, however it is not intended that they actually work with the specificity of a computer program. Any technical issues with implementation of the flowcharts (e.g., endless loops, redundancies, etc.) would be addresses by one of ordinary skill in the art in order to be consistent with the spirit and scope of the inventive concepts herein. It is further noted that numerous different algorithms, orders of operations, etc., can be used and the inventive concept is not limited to the exact order/implementation shown.

FIGS. 4-5 illustrate an automatic check in system, which runs in the background on the player's portable device and automatically displays pop-up alerts allowing players to automatically check in to particular homes, neighborhoods, and cities. In another embodiment, the check in process can be manual, that is when a player wants to check into a particular home, neighborhood, or city, the player must visit a special page for home check in, neighborhood check in, or city check in to check in to these locations.

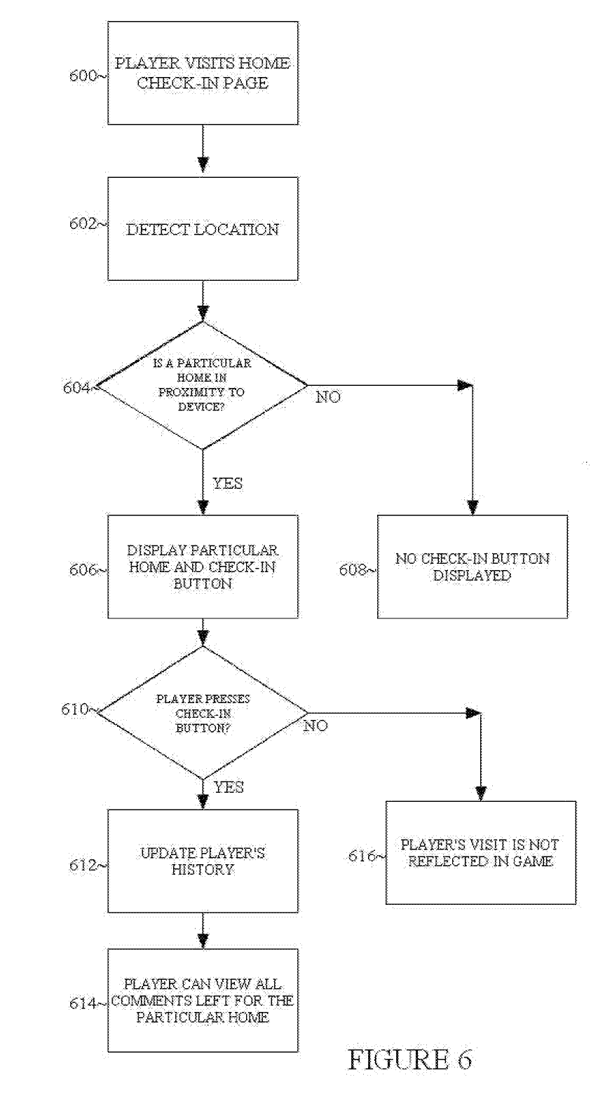

FIG. 6 is an exemplary flowchart illustrating a method of manual home check in, according to an embodiment.

The method can begin with operation 600, wherein the player visits a home check-in page. He can visit this page by navigating a series of menu screens on the application running on the player's portable device.

From operation 600, the method proceeds to operation 602, which detects the location of the portable device. This can be performed as described in operation 400.

From operation 602, the method proceeds to operation 604, which determines if the player's location (or technically the location of the portable device) is in close proximity to the portable device (or the home that is the closest to the portable device). A database of homes is accessed, each home in the database having respective geographical coordinates (or a range of coordinates) that define the physical location of the house. This actual coordinates of the portable device can be checked against the database to determine which, if any, home is in close proximity (e.g., 10 feet or other predetermined range) to the portable device.

If in operation 604, it is determined that there is no home in close proximity to the portable device, then the method proceeds to operation 608, wherein no check-in button is displayed on the home check-in page displayed in operation 600.

If in operation 604, it is determined that there is a particular home in close proximity (or if multiple homes, the closest one) to the portable device, then the method proceeds to operation 606, which displays the particular home determined from operation 604 and also check-in button for the particular home.

From operation 606, the method proceeds to operation 601, which determines if the player presses the check-in button (displayed in operation 606), and if so, then the method proceeds to operation 612, which updates the player's history to reflect the visit to the particular home (as in operation 406). It is also disclosed to all of the other players that are checked in to this home that the player has checked in and the player's interest.

From operation 612, the method proceeds to operation 614, wherein the player can view all comments left for the particular home and can also post comments as well for all other players who check into this house to see. The player can view all MLS information about the home as well as the feedback and content left by other players for the particular home. See operation 412 for more details.

If in operation 610, the player has not pressed the check-in button, then the method proceeds to operation 616, wherein the player's visit to the particular home is not reflected in the game. The player cannot see the feedback and content left by other players about this home and the player does not get game credit for exploring the home. The method can return to operation 610 so that the player has more time to press the check-in button.

In the same manner that the player can manually check into a particular home, the player can also check into a neighborhood.

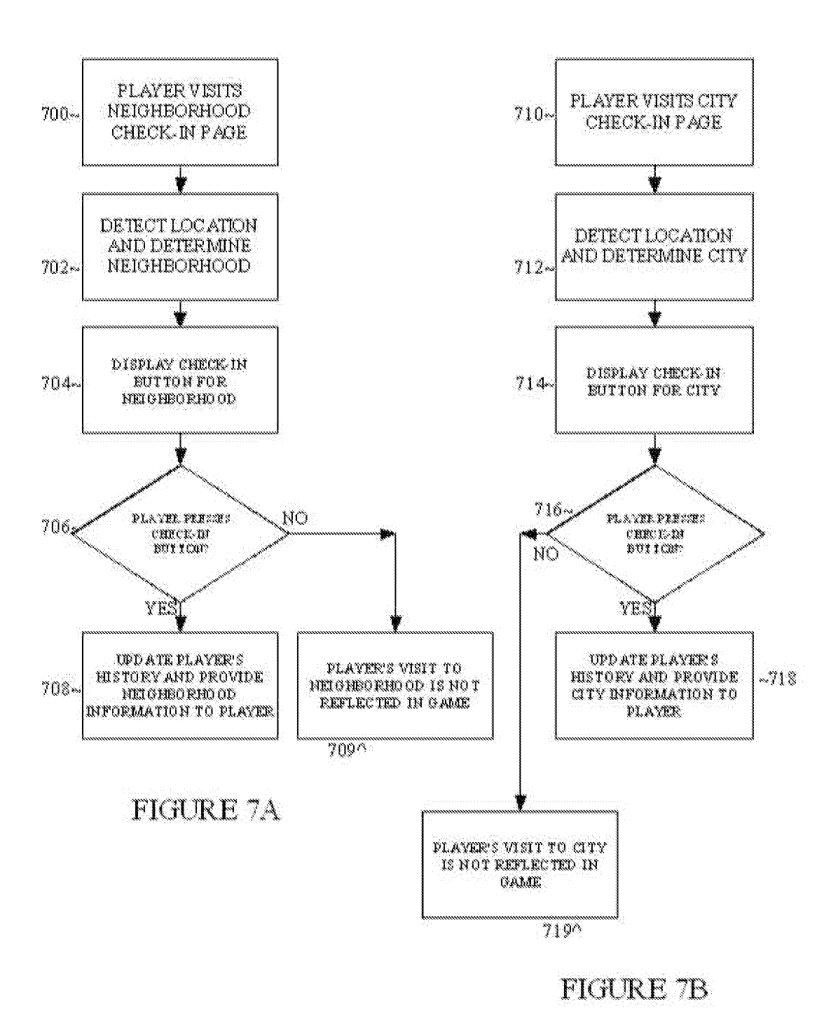

FIG. 7A is an exemplary flowchart illustrating a method of manual neighborhood check in, according to an embodiment.

The method can begin with operation 700, wherein the player visits a home check-in page. He can visit this page by navigating a series of menu screens on the application running on the player's portable device.

From operation 700, the method proceeds to operation 702, which detects the location of the portable device. This can be performed as described in operation 400. The neighborhood the portable device is in can also be determined by accessing a database (or local data file) with different neighborhoods and their actual physical locations (e.g., coordinate ranges) so the system can place the portable device in a particular neighborhood. If for any reason the neighborhood of the portable device cannot be determined (e.g., the physical location of the portable device is not mapped to any neighborhood in the system), then the method can just not proceed to operation 704.

Once the neighborhood is determined in operation 702, the method proceeds to operation 704, which displays the detected neighborhood and displays a check-in button for this neighborhood.

From operation 704, the method proceeds to operation 706, which determines if the player presses the check-in button. If not, then the method proceeds to operation 709, wherein the player's visit to the neighborhood (determined in operation 702) is not reflected in the game. Thus, the player cannot see the feedback and content left by other players about this neighborhood and the player does not get game credit for exploring the neighborhood. The method can return to operation 706 in order for the player to be given more time to press the check-in button.

If in operation 706, the player has pressed the check-in button, then the method proceeds to operation 708, which updates the player's history (as in operation 506) and provides the neighborhood information to the player. In real time it is disclosed to all of the other players that are also checked in to this neighborhood that the player has checked in to this neighborhood and his or her interest.

In the same manner that the player can manually check into a particular home, the player can also check into a city.

FIG. 7B is an exemplary flowchart illustrating a method of manual city check in, according to an embodiment.

Operations 710, 712, 714, 716, 718, 719 can be performed in the same manner as operations 700-709, but for cities instead of neighborhoods.

The system described herein is designed to encourage home buyers to select an agent patron in order so that they can access all of the information and features provided herein.

Once a player checks into a location (city, neighborhood, or home), then the player does not have to check in again to that location. That location is added to a list of places that the player can access again because the player has been there already. When player's view a list of people who have checked in to a particular location, the list can be ordered by date/time checked in, in other words the most recent players who checked in are displayed first and the least recent who checked in are displayed last. If a player does not check out of a neighborhood manually, then typically the system would not check the player out automatically. When the player restarts the application (game) on the player's portable device, the device will show that the player is still checked in to that location until the player manually checks out. Once the player checks out, then the game figures out where the player is and can ask the player if he or she wants to check into a location (city, neighborhood, home) the player is currently near.

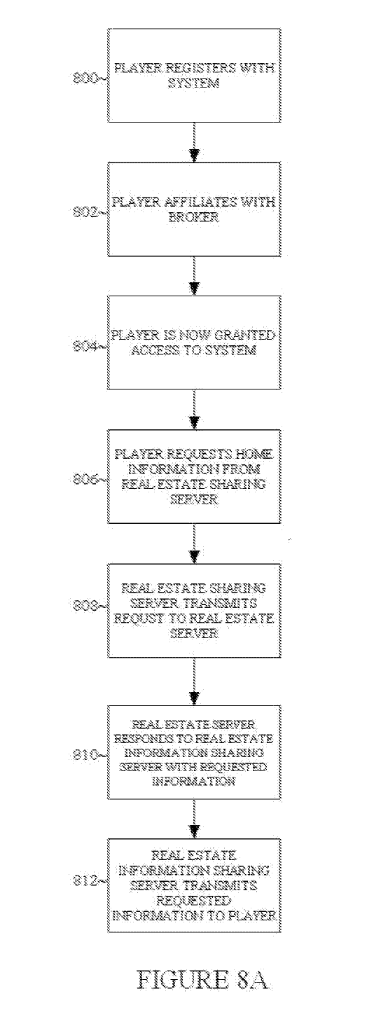

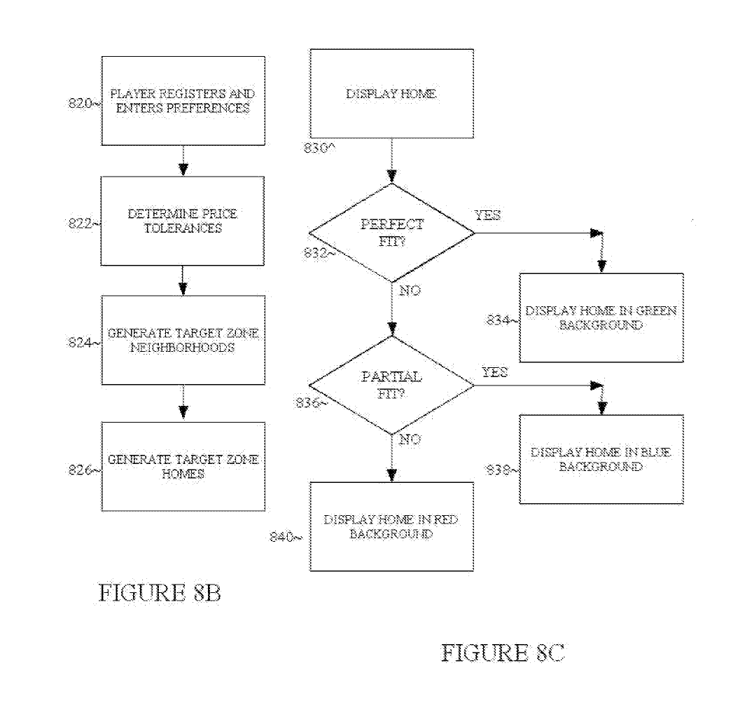

FIG. 8A is an exemplary flowchart illustrating a dataflow of how a player can access information from the system, according to an embodiment.

The method can begin with operation 800, wherein the player registers with the system. See operation 300 for more details of this operation. “System” as used herein refers to all of the features described herein and the server(s) and hardware used to implement them. Typically, a real estate sharing information server (see FIG. 16, item 1604) is the server that administers the system and communicates with the portable devices used by the players.

From operation 800, the method proceeds to operation 802, wherein the player affiliates with a broker. See operation 308 for more detail on this process. The player can be presented with listings of potential brokers (agents) and their biographical information, etc., so the player can choose one that the player is comfortable with.

From operation 802, the method proceeds to operation 804, wherein now that the player has affiliated with a broker, the player is now granted full access to the system and is free to view all of the available information described herein (subject to the conditions described herein, for example a player must still check into a home to see all of that home's information). Thus, the player has now unlocked the “home-level” information including the MLS home information and statistics.

From operation 804, the method proceeds to operation 806, wherein the player requests home information (about a particular home the player is interested in) from the real estate information sharing server. Note that individuals generally may not be allowed direct access to a real estate server 1602 (such as the MLS database server) which only responds to requests from agents/brokers affiliated with it.

From operation 806, the method proceeds to operation 808, wherein then the real estate information sharing server requests the home information (that the player requested in operation 806) from the real estate server.

From operation 808, the method proceeds to operation 810, wherein the real estate server responds to the real estate information sharing server with the requested home information. Since the real estate information sharing server has the proper affiliation with the real estate server, the real estate server will respond to the real estate information sharing server with the requested information.

From operation 810, the method proceeds to operation 812, wherein the real estate information sharing server then transmits the requested information to the player. In this manner, the player is able to access the data on the real estate server even though the player isn't directly affiliated with the real estate server by affiliating with an agent/broker listed on the real estate information sharing server.

Thus, by implementing the method in FIG. 8A, a player can receive information from the real estate server (which can be a proprietary database such as the MLS) indirectly through the player's associated agent (or patron). While the player associates (or affiliates) with the agent using the application described herein, the player typically has no legal obligation to use the agent as the player's realtor when purchasing any home (although the player could certainly do so if the player wanted to). The player typically would not have access to the information from the real estate server alone (the player is not a realtor) and thus in this manner the player is able to access the propriety information in the real estate server. Typically, the real estate server would not provide some or all information about a home to a party unless the party was a realtor (which may require verification that the realtor is licensed) that is registered with the real estate server. Thus, one advantage of the system herein is that now a player (by virtue of playing the application and picking an agent) can have access to the full information in the real estate server.

It is further noted that the player can remain anonymous to the agent that the player chooses. This means that the agent will not know the player's real name or identity and would only know the player's screen-name (account name) that the player used to register with the system (see operation 300). While the player is anonymous to the agent, typically the agent is not anonymous to the player because the player would typically have the opportunity to review a number of different agents' real life information on the system/application (real name, photo, work history, etc.) before the player chooses which agent the player wishes to affiliate with. This direct channel with a real estate agent that is semi-anonymous in that the player does not have to disclose his or her name, email address, or phone number and only discloses his or her game username as the sole channel of communication between agent and player until the player has become comfortable with the agent. Thus, a method is provided for players interested in receiving access to real estate information including MLS information can do so without having to make a formal or tacit real-life commitment to a real estate agent (which can involve signing a real non-anonymous contract) until that person is ready to make a commitment.

When a player registers the player enters preferences so that the system can identify the player's target (ideal) neighborhoods and homes by matches characteristics of the neighborhoods and homes it has in its database with the player's.

FIG. 8B is an exemplary flowchart illustrating a method of generating target neighborhoods and homes, according to an embodiment.

The method can begin with operation 820, wherein the player registers with the system and enters the player's preferences. This is done as described herein and known in the art. The player can enter his or her desired home criteria including their total monthly low and high range for the mortgage or rent payment (or more simply the desired home price range). The player can also enter information such as desired down-payment, mortgage rates, etc., so that the system can compute minimum and maximum home price tolerances. In addition to the financial information, the player can enter personal preference information (e.g., number of bedrooms, bathrooms, lot size, etc.) so that the system can identify what type of home the player would like to see.

From operation 820, the method proceeds to operation 822, which determines price tolerance. From the financial information the player entered, the system can determine a price range that the player can afford. This can be done as known in the art using known mathematical formulas (e.g., given player's income minus debt the maximum monthly mortgage payment can be calculated from which the maximum home prize can be computed).

From operation 822, the method proceeds to operation 824, which generates target zone neighborhoods. Target zone neighborhoods are neighborhoods which have an average home price in the range of the player's home price range determined in operation 822. The target zone neighborhood list can be generated by querying the game database to retrieve the target zone neighborhoods. The determined target zone neighborhoods can be displayed to the player. They can also be highlighted (for example in a particular color) when they are being displayed on the portable device. The player can also be rewarded with points and achievement badges for checking into the determined target zone neighborhoods.

From operation 824, the method proceeds to operation 826, which generates target zone homes. Target zone homes are homes which meet both the player's financial criteria (e.g., the selling price is within the range the player can afford as determined in operation 822) and also matches the player's personal preference information (e.g., number of bedrooms, square footage, etc.) The player's target zone homes will automatically update frequently as new data from the MLS server is received by the game. Homes that are sold are removed from the list and newly listed homes that would qualify as a target zone home would be added to the list of target zone homes. The player can be alerted in real time to any changes on the player's target zone home list.

The player would also get additional points and achievement badges for checking into homes on the player's target zone home list. When the player views a target zone home on the game, each target zone home is highlighted as such.

When viewing any home listing on the portable device, the background color of the home can be used as a key to easily identify to the player a category of the home being viewed (a perfect match, a partial match, or no match).

FIG. 8C is an exemplary flowchart illustrating a method of displaying homes using a color key, according to an embodiment.

The method can begin with operation 830, which displays a home on the portable device. The home can either be displayed in abridged form (in a list of homes) or a full listing of the home.

In operation 832, it is determined if the home being displayed is a perfect fit with the criteria that the player entered in operation 820. If the sale price of the home being displayed falls within the player's purchase range (determined in operation 822) and the home's characteristics match the player's personal preference information (entered in operation 820) then the home being displayed would be a perfect fit and the method would proceed to operation 834, which displays the home using a green (or any color) background to signify a perfect fit.

If in operation 832, the home being displayed is not a perfect fit, then the method proceeds to operation 836, which determines if the home being displayed is a partial fit. A partial fit is where the price of the home being displayed falls into the player's purchase range or tolerance (determined in operation 822) but the characteristics of the home being displayed do not match the players personal preferences (e.g., the player is looking for a 4 bedroom home but the home being displayed is a 3 bedroom home). If the home being displays is a partial fit, then the method proceeds to operation 383, which displays the home using a blue (or any other color different than the color in operation 834) background to indicate a partial fit.

If in operation 836, it is determined that the home being displayed is not a partial fit, then the method proceeds to operation 840, which displays the home in a red background (or any other color different than the color in operation 838) to indicate that the home is neither a perfect or a partial fit.

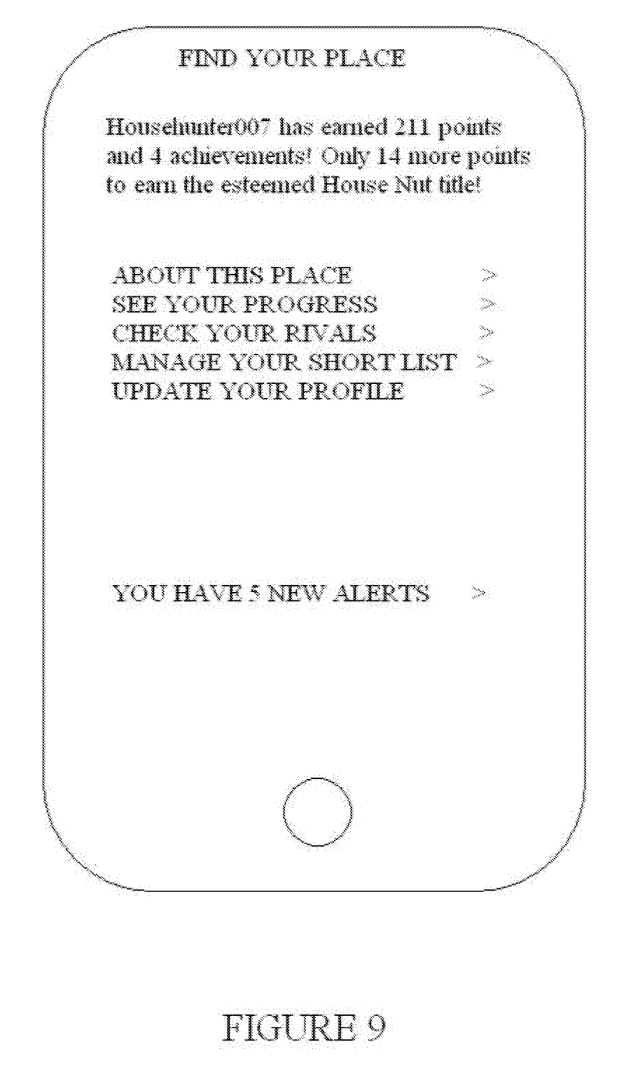

FIG. 9 is a drawing of a portable device showing a main menu, according to an embodiment.

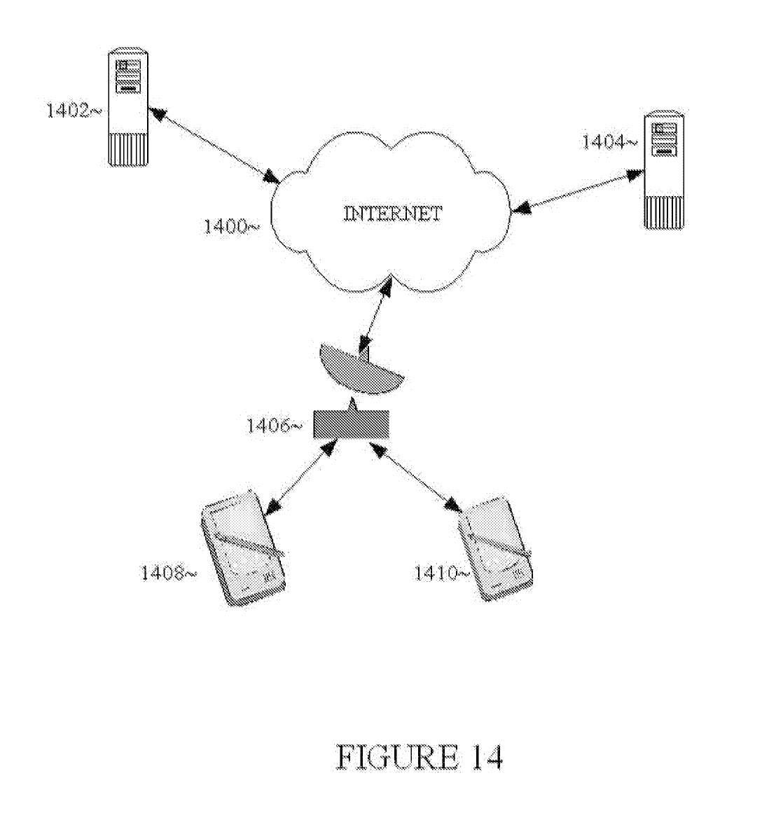

The main menu can display different options for the player to receive different screens of information. For example, the player can select “about this place” which tells the player where he or she is (city, neighborhood, and individual home) and relevant information about the city, neighborhood and home (e.g., population, average income, school district quality, home price, size, etc.) The “see your progress” option lets the player see how many points the player has earned and any achievements the player has received. The “check your rivals” option displays to the player the player's rivals and their relative ranking (see FIG. 14B). The “manage your shortlist” option will keep track of a player's favorite homes and whether they have price reductions, go under contract, etc. The player can also select “update your profile” which allows the player to change his or her profile (e.g., information about the player that other plays can see, such as hobbies, age, sex, etc.) and also the player's preferences regarding the house they are looking for.

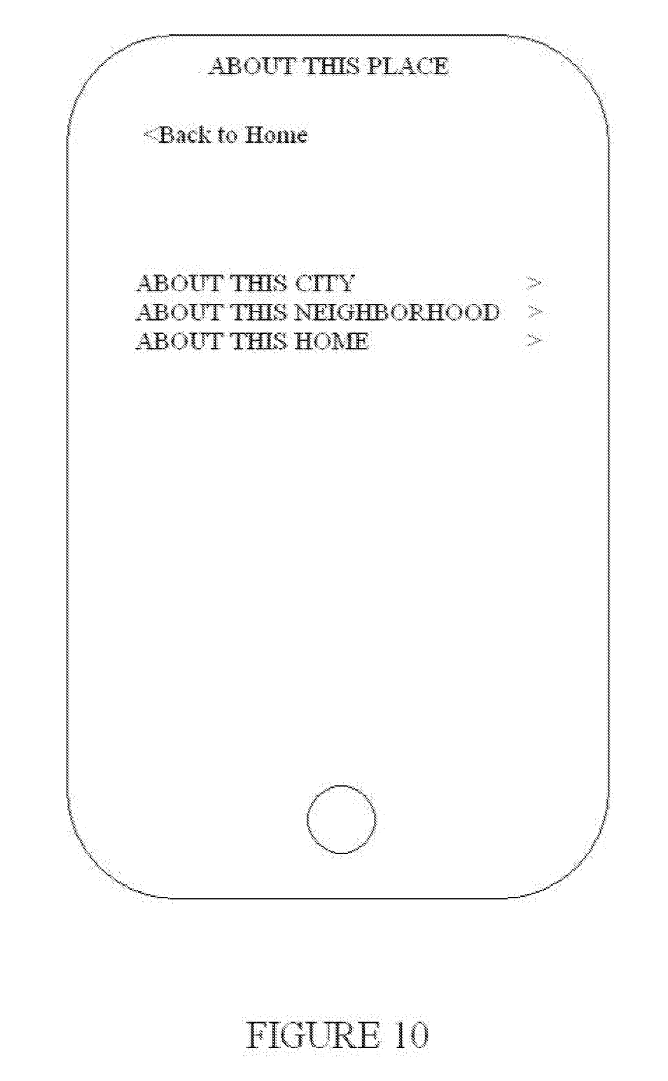

FIG. 10 is a drawing of a portable device showing an informational menu, according to an embodiment.

If, from the menu shown in FIG. 6, the player selects the “ABOUT THIS PLACE” option, then the menu in FIG. 7 appears. From this menu, the player can select “ABOUT THIS CITY” which displays information to the player about the current city the device is physically located in. The player can also select “ABOUT THIS NEIGHBORHOOD” which displays information to the player about the current neighborhood the player is physically located in The player can also select “ABOUT THIS HOME” which displays information to the player about the current home the player is in or in close proximity to.

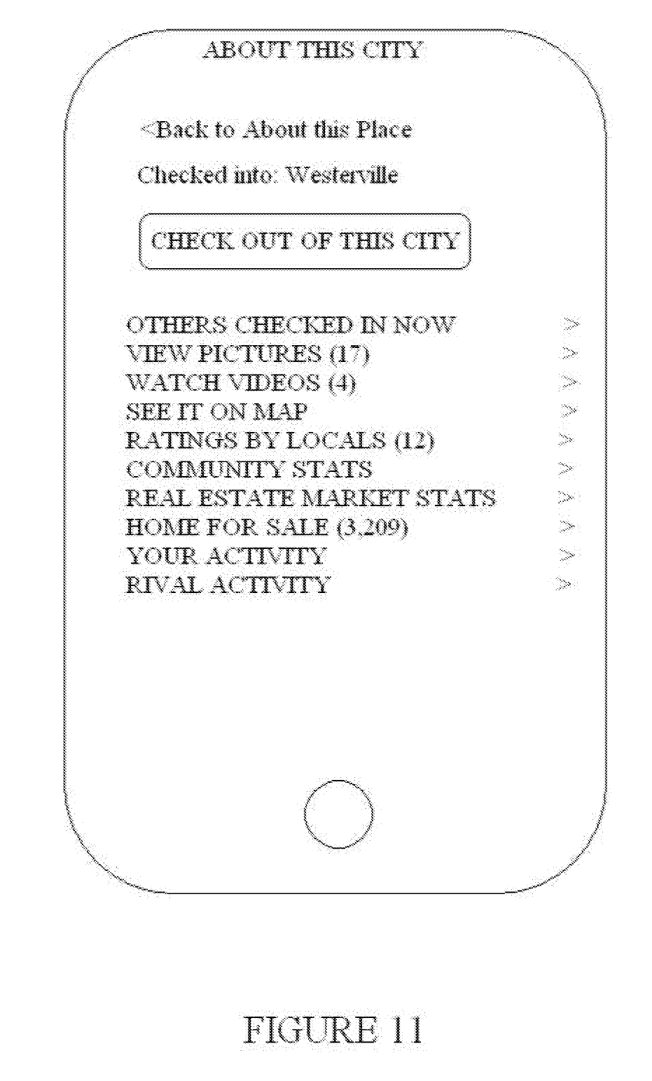

FIG. 11 is drawing of a portable device showing a city menu, according to an embodiment.

The information in FIG. 11 is displayed when the player selects “ABOUT THIS CITY” from the menu in FIG. 10. This displays the city that the player is checked in to. A “check out” button is present which allows the player to check out of the city if the player wishes.

From this menu, the player can select “OTHERS CHECKED IN NOW” which shows the other players that are also checked in to the same city. The player can also select “VIEW PICTURES” which shows pictures of the city. Players are also free to post their own pictures for viewing by other players. The player can also select, “WATCH VIDEOS” which can display videos of or about the city. Players are also free to post their own videos for viewing by other players. The player can also select, “SEE IT ON MAP” where they can view a map locating the city they are checked in to (e.g., Westerville). The player can also select, “RATINGS BY LOCALS” which display ratings of this city given by locals. The player can also select, “COMMUNITY STATS” which can display statistics about the city, such as population, average income, etc. The player can also select, “REAL ESTATE MARKET STATS” which can display statistics about the real estate market for that city, such as the number of homes for sale, average selling price, average time on the market, etc. The player can also select, “HOME FOR SALE” which would display to the player all of the homes or sale in the city (which can be subject to further filtering by the player). The player can also select, “YOUR ACTIVITY” which displays the player's activity, such as the cities, neighborhoods, and homes for sale the player has visited, and the dates visited. The player can also select, “RIVAL ACTIVITY” which displays a list of the player's rivals and their individual activities. The player can select an individual rival on the list which then shows their profile page and all their recent check ins and indicates on the list of neighborhoods and homes which he is rivaling the player for in interest and check ins. The player can also send a message to this rival unless this rival has blocked the player.

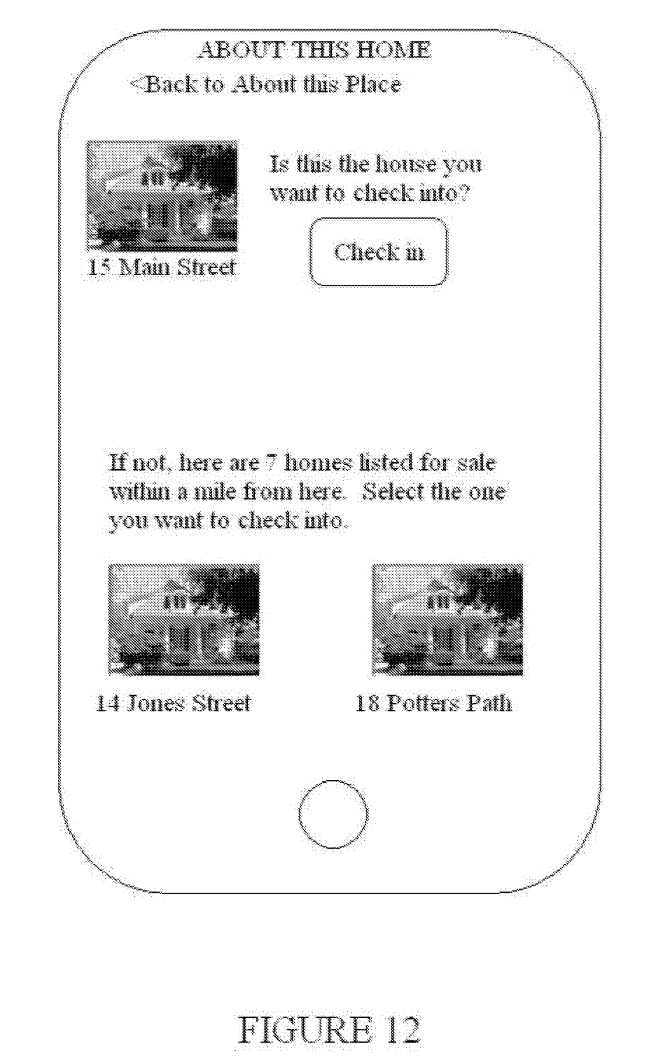

FIG. 12 is a drawing of a portable device showing a check in screen, according to an embodiment.

From the menu in FIG. 10, if the player selects “ABOUT THIS HOME” the player can be brought to the screen in FIG. 12. Upon reaching this screen, the system (in an embodiment) can locate the device and determine if it is inside (or very close to) a home for sale, and if so, then it can display the check-in prompt which allows the player to check into the home shown by pressing the “check in” button.

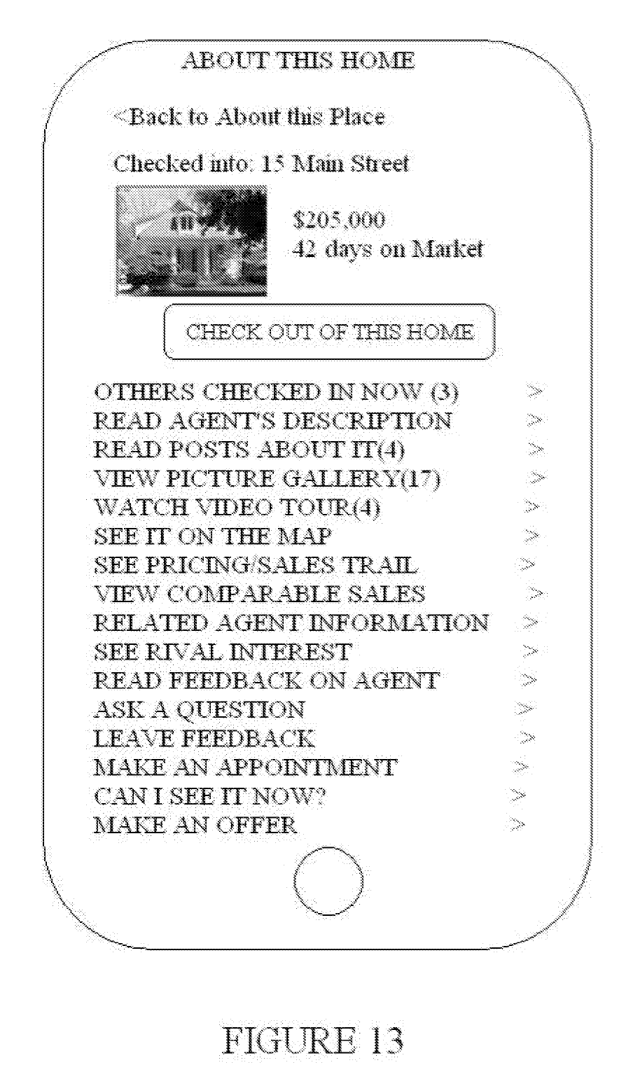

If the player checks in (presses the “check in button”) then the player can be brought to the menu in FIG. 13.

FIG. 13 is a drawing of a portable device showing a home menu, according to an embodiment.

This menu provides the player with information about a particular home for sale that the player is checked in to. Such information can be selling price, time on market, etc. A “check out” button is available which allows the player to check out of this home as well. Once a player checks out, he will still be able to return to this screen (since he has already checked in at least once) in order to see all this information again, even if the player is no longer physically located near this home. While checked in, other players can see that the player (known only to other players by his username) is visiting this home.

This menu allows the players to select a number of sub-screens which provide additional information. For example, the player can select “OTHERS CHECKED IN NOW” to list the other players (by username) that are currently checked in to this home. The player can also select, “READ AGENT'S DESCRIPTION” which displays the agent's description of this home. The player can also select, “READ POSTS ABOUT IT” which displays posts posted by other players that have already visited this home (and checked in). Just by checking in allows the player to read posts about a home, even if the player hasn't posted anything himself. The player can also select, “VIEW PICTURE GALLERY” which displays pictures of the home, some which are posted by other players who visited this home. The player can also take pictures of the home and post them to be viewed here as well. The player can also select, “WATCH VIDEO TOUR” which displays videos of the home, some which are posted by other players who visited this home. The player can also take videos of the home and post them to be viewed here as well. The player can also select, “SEE IT ON THE MAP” which displays this home on a map. The player can also select, “SEE PRICING/SALES TRAIL” which shows the pricing information of this home and other times it has been sold and respective selling prices. The player can also select, “VIEW COMPARABLE SALES” which shows nearby homes and their selling prices. The player can also select, “RELATED AGENT INFORMATION” which can display information on the agent listing this home. The player can also select, “SEE RIVAL INTEREST” which displays information about the player's rivals and which of them have visited this particular house. Rivals are used as a mechanism to help players who are interested in a home or neighborhood to know if they need to make a decision quickly based on information about someone else who is sniffing around the same place. The player can also select, “READ FEEDBACK ON AGENT” wherein the player can see feedback about the particular agent listing this home. The player can also select, “ASK A QUESTION” which allows the player to type in a question which would get transmitted to the seller (or the seller's agent), whereupon the seller can reply and both the question and answer can be viewable by players who have checked in to this home. The player can also select, “LEAVE FEEDBACK” which allows the player to post a post about this home viewable by other players who have checked in to this home. The player can also select, “MAKE AN APPOINTMENT” which allows the player to make an appointment with the seller (or seller's agent) in order to discuss the home. The player can also select, “CAN I SEE IT NOW” which allows the player to arrange an appointment to see the home. Checking in to a home may be typically done from a car or in front of the house (although it can also be done inside the house if the player has access). The player can also select “MAKE AN OFFER” which allows the player to make an offer to the seller (or the seller's agent) using the portable device.

In order to foster a sense of community among players, “competitions” can be formed between a player and his or her rivals. For example, among a player and his or her rivals, a rank can be generated of those players and the number of homes each has seen in a particular neighborhood.

FIG. 14 is a block diagram of components of a network that can be used to implement the methods described herein.

A computer communications network such as the Internet 1400 is used to implement the methods described herein. The internet cloud 1400 includes all necessary components (routers, etc.) which are not individually pictured. A real estate server 1402 serves as both a database (storing real estate information) and a server to serve requested real estate information to requesting parties. For example, real estate server 1402 can be a server that stores MLS listings which are accessible across the Internet. A real estate information sharing server 1404 is used to implement the methods described herein. For example, the real estate information sharing server 1404 stores all the information about players (e.g., their preferences, account information, playing history, etc.), as well as all of the posts, videos, etc., left by players. The application that each player runs on their portable device communicates extensively with the real estate information sharing server 1404 in order to transmit and receive the necessary information. The real estate information sharing server 1404 communications with the real estate server 1402 in order to retrieve public listings of homes which are then transmitted (as needed) by the real estate information sharing server 1404 to the individual users. The real estate information sharing server cooperates with the user's portable device in order to implement all of the Figures and methods described herein.

Portable devices 1408, 1410 can be cell phones or PDAs that have the capability to run applications and communicate wirelessly with the internet. Portable devices 1408 and 1410 would each install the same application and would allow their owners to be different players in the system. The two players (of course the system can accommodate many more players) can communicate with each other as described herein (by posting messages, becoming rivals, sharing pictures/video, etc.)

It is noted that the MLS database system currently in use does not allow individual home buyers to directly access the system. Thus, if the real estate server 1402 is the MLS database system, then the way that the users of the portable devices 1408, 1410 can access the MLS database system is by going through the real estate information sharing server 1404. The real estate information sharing server 1404 has the appropriate license or relationship with the MLS database system such that that the MLS database system would share its database with the real estate information sharing server 1404. Since users of the portable devices 1408, 1410 must affiliate with a sales agent before being able to fully use the system (described herein), the real estate information sharing server 1404 serves to encourage home buyers to affiliate with a sales agent. Once a home buyer is affiliated with a sales agent, then that would typically satisfy the prerequisites for the MLS database system to be able to serve them information from the database.

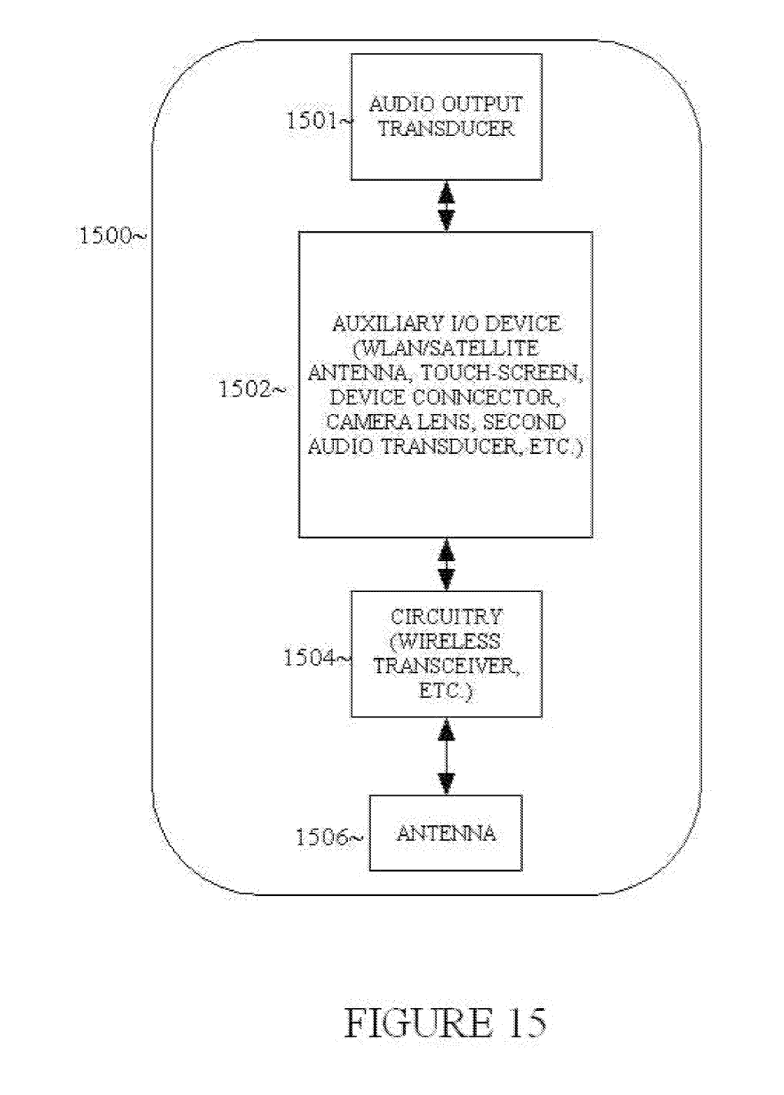

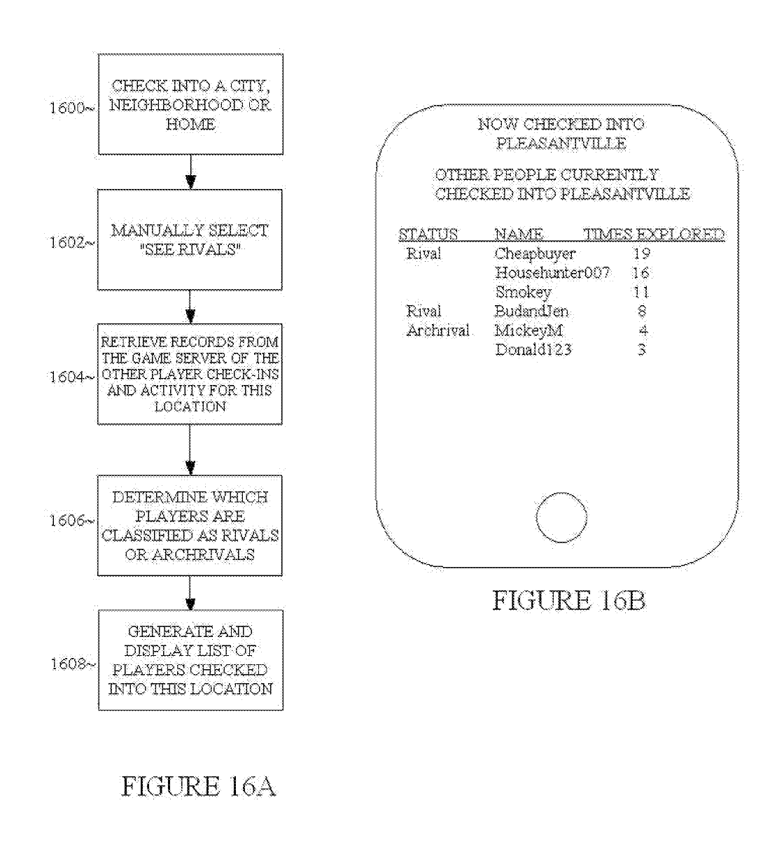

FIG. 15 is a block diagram of a portable electronic device that can be used to implement the methods described herein.

The methods described herein can be executed on a downloadable application on a known portable computing device (e.g., cell phone, PDA, etc.), for example, the kind that is described in U.S. Pat. No. 7,696,935 (which is incorporated by reference herein in its entirety). The application to execute the methods described herein can be distributed by a wireless application distribution service (e.g., “APP-STORE”) and downloaded by an owner of the portable device (the user/player) for free or for a purchase price.

The cell phone 1500 comprises an audio output transducer 1501, an auxiliary I/O device 1502, other circuitry 1504, and an antenna 1506. Of course, this is a very high level diagram and other components are not pictured. Not pictured is a processing unit which can execute instructions and communicate with an output device (e.g., touch-screen), an input device (e.g., touch-screen), and a storage device (all interconnected). The storage device can store an application (a series of computer instructions) that can execute all of the methods described herein on the cell phone.

FIG. 16A is a flowchart illustrating a method of displaying a player's rivals, according to an embodiment.

The method can begin with operation 1600, wherein the player checks into a city, neighborhood, or home. This can be done using any of the methods described herein, although the player must manually confirm his or her checkin to this location (e.g., by pressing a confirmation button on screen).

From operation 1600, the method proceeds to operation 1602, wherein the player would manually select to view the rivals list. This can be done by navigating the menu panes on the device to select the proper navigation button to bring up the rival list window.

From operation 1602, the method proceeds to operation 1604, which retrieves records from the game server (database) of the other player check-ins and activity for this location. Each time any player checks into a location, it is stored and indexed in the database (such as real estate information sharing server 1404) so a list of all players that are currently (or have previously) checked in to this location (that the player checked in to in operation 1600) can be retrieved.

From operation 1604, the method proceeds to operation 1606, which determines which of the players that have ever checked in to this location are classified as rivals or archrivals. This can be done by using an algorithm that weights different factors to determine which of these players have a compatibility score high enough to be considered a rival or an archrival (must have a very high compatibility score). A score is determined by adding different factors tougher (each of the factors can be weighted) Factors that can go into this determination are (in the order of importance): the amount of feedback and communication activity for this location by each of the other players currently checked in to this location identified in operation 1604 (the more feedback and communication activity the higher their score); the check-in activity of each of the other players currently checked in to this location (the more places checked in to the higher the score) and a comparison of home preferences between each of the other players that have ever checked in to this location and the player (the closer the preferences the higher the score).

For example, the comparison of the home preferences can be compared as follows. If the player is looking for a house in a particular price range (e.g., $400k-$500k) and another player (currently checked in to this location) that have also indicated their preference in this same range then the another player would get additional points in the score. If the player is looking for a house in a particular zip code, and another player (currently checked in to this location) has also indicated in their preferences to be looking in this zip code, then the another player would also get additional points in the score. Each of the other players identified to have ever checked in to the current location would each get their own score. Higher scores represent a higher compatibility with the player.

If other players that have ever checked in to this location have a score lower than a predetermined threshold, they would not be considered a rival or an archrival. If the score is greater (or greater than or equal to) the predetermined threshold but lower than a second predetermined threshold, then the other player would be considered to be a rival. If the score is greater than equal to the second predetermined threshold, then the player would be considered an archrival. The second predetermined threshold would of course be higher than the first predetermined threshold. It is also noted that check-ins can expire after a certain amount of time. For example, after predetermined period of time (i.e. a year, month, etc.) after a player checks into a location, that check-in will no longer be used because it is too old (thus such a player who checked in to the current player's currently checked-in house more than the predetermined time ago will not be available to be considered as a rival or archrival to the current player).

From operation 1606, the method proceeds to operation 1608, which generates and displays the list of players who have ever checked in to this location (from operation 1600) and each players' status (whether they are a rival, archrival, or neither). If the list of players currently checked in is too great, then the list can be limited to simply players that are rivals or archrivals. The list can also be abridged based on the date of check-in (e.g., most recent checkins are displayed first).

In addition to checking into homes, players can check into other locations as well, such as landmarks. For example, in each city or neighborhood there can exist landmarks, such as a well known restaurant or historic site. Players can physically visit and check into landmarks and earn points by doing so. When a player checks into a landmark, the game reveals the location of three other landmarks in the city that were previously undiscovered. The player also has the option to send up to three “souvenirs” (or messages notifying the players of the landmark location) to other players (including rivals) to notify them of the landmark and give them points for receiving the message. Thus Landmarks are hidden special places in a city that can only be discovered for points 2 ways: receiving a souvenir notification of a landmark or being disclosed the landmark by the game upon finding another landmark. Otherwise, it is not possible to check into a landmark even when at the correct location. This creates a sense of cooperation between players as the souvenirs become rare and valuable to unlock the available landmarks. Players can also communicate with other players directly by sending/receiving messages (similar to email without revealing player email addresses or phone numbers) through the system, other players can be identified by their usernames.

FIG. 16B is a drawing of a portable device showing a list of players currently checked in to the player's location, according to an embodiment. This list (or ranking) can be generated using the method illustrated in FIG. 16A. The player has manually checked in to Pleasantville (such as in operations 716-718). The list in FIG. 16B displayed on the portable device shows all of the players currently checked in to Pleasantville. It is noted that a player cannot check into a location (city, neighborhood, or home) unless the player is physically present in that location (of course while carrying the portable device). The list of players also shows each of the players' respective number of times that player has checked in to (explored) this location. The list also show whether each of the players has a status of rival, archrival, or no such status. The players marked rival have been determined (by using the weighted algorithm described above) to have common interests (compatibility) with the player, and the player(s) marked archrival are determined (by using the weighted algorithm described above) to have strong common interests (compatibility) with the player. While the list in FIG. 16B displays the other people currently checked in to Pleasantville, a similar such list can be generated of players who have ever checked in to Pleasantville (or who have checked in within a predetermined period of time).

Thus, when a player checks into a city, home or neighborhood, the player can see all the other players that have checked in that location (including their status as a rival or arch-rival) in real-time as well as their activity. This provides an important piece of market information that is currently not available that can help both buyers and sellers gauge the need for urgency in a purchase scenario. The player understands that by checking into the neighborhood or home, that the player is disclosing the same information to the other players checked in to this location as well.

Agents can also earn titles for their responsiveness and diligence with helping players in the game which will ultimately reward them by helping them earn new client relationships. The game can also track an agent's response rate and timing to questions asked about homes, to how many pictures they have added to a home, whether they uploaded a video, etc. These metrics lead to achievements which show the agent is diligent, responsive, etc through their activities in the game. Home owners can also see metrics that are otherwise invisible to them on how professional and timely their agents are responding to house hunter interest and inquiries.

A player's affiliated agent (or broker) in the game (see FIG. 8) can also automatically view the locations (houses, neighborhoods, cities) that the player has checked in to. Thus, the player's check-in history (the locations the player has checked in to and their respective dates) can be transmitted electronically to the player's agent. In an embodiment, whenever a player checks in to a location the system will automatically send an alert (in the game using for example the real estate information sharing server 1404) to the player's agent notifying the agent of the player and the location the player has just checked in to. The agent can then use that information to help the player by sending recommendations and additional information about those homes and areas to the player. This also allows agents to anticipate the information needs of potential clients based on their real estate investigation activities and where they are focusing their interest so that agents can proactively anticipate information requirements about those areas and homes and proactively research and send them to the player. This can help the agent earn the trust and appreciation of the potential client that could potentially result in a new agent-client relationship.

Tracking and tabulating all of the check-in information from all of the players in the game allows sellers/landlords, home buyers/tenants, agents, or other interested parties to access information to the level of interest into a particular home or neighborhood. Transparency of this information is important to help seller/landlords and their agents to price their properties accurately and for buyer/tenants and their agents to make a well-informed offer. The activity tracking herein tracks “the wisdom of the crowd” who vote with their check-ins and makes open this interest activity to all interested parties. In addition, information about the pricing and positioning of homes can be provided to home owners. Every time that a home buyer checks in to a home or neighborhood, or even reads about a home or neighborhood using the game system adds to the aggregate level of interest in a home or neighborhood. Additionally, each time a home buyer returns for a second or third time to view the same house from the exterior or to re-tour the neighborhood, even more valuable information about specific information is aggregated. The system described herein collects, aggregates and disseminates this home buyer activity so that home owners can view this information (if they subscribed to the system) and gauge the level of interest in their home or neighborhood both absolutely and relative to other homes and neighborhoods that may be competitive. The collection and transparency of this information should be critical to home owner's pricing and marketing strategy, and also critical to home buyers who can better understand the necessitated urgency to act on a specific home.

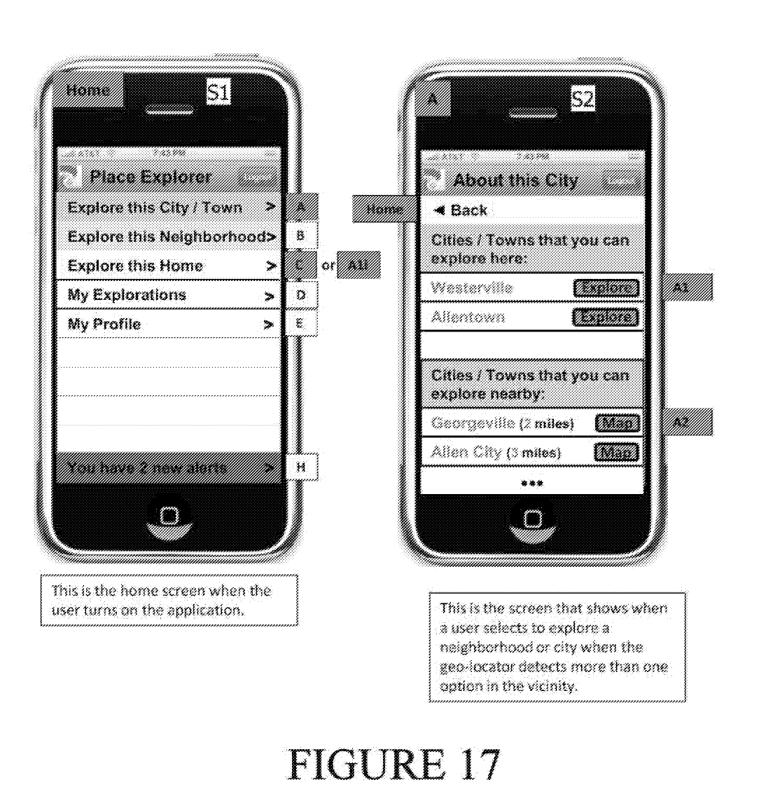

FIGS. 17-48 illustrate example output screens of various aspects of the methods described herein shown on a cellular phone. The identifier in the upper left of each cellular phone refers to that particular screen. When other identifiers appear on each screen, touching the adjacent text or bar will bring up the screen associated with that identifier. The upper right of each screen also contains another identifier identifying the particular screen. The word explorer(s) in the figures is synonymous with the words user(s) and player(s).

FIG. 17 is a drawing of a first set of output screens on a mobile device, according to an embodiment.

S1 represents a Home Screen, which shows the 3 different levels of Places you can explore as well as 5 other game options. When you start the Application, Place Explorer waits for to decide which city, town or home you want to explore It knows what the options are based on the geo-locator already in your phone. Place Explorer knows what neighborhood you are standing in because the neighborhoods have been drawn, described, moderated, and stored on a Google Map on YourPlace.com. Place Explorer has complete, real-time information about all the homes listed for sale in your area because we have a real time connection to your local Realtor MLS.

S2 represents a Select a City Screen, which can be activated if the user happens to be standing within the boundaries of 2 city/towns. This happens sometimes in larger cities that have smaller unincorporated areas inside. The user can choose which city he or she is interested you are exploring. Place Explorer also tells the user about the city/towns that are nearby. If he or she wants to explore one of these places, the user can see how far away they are and even map them.

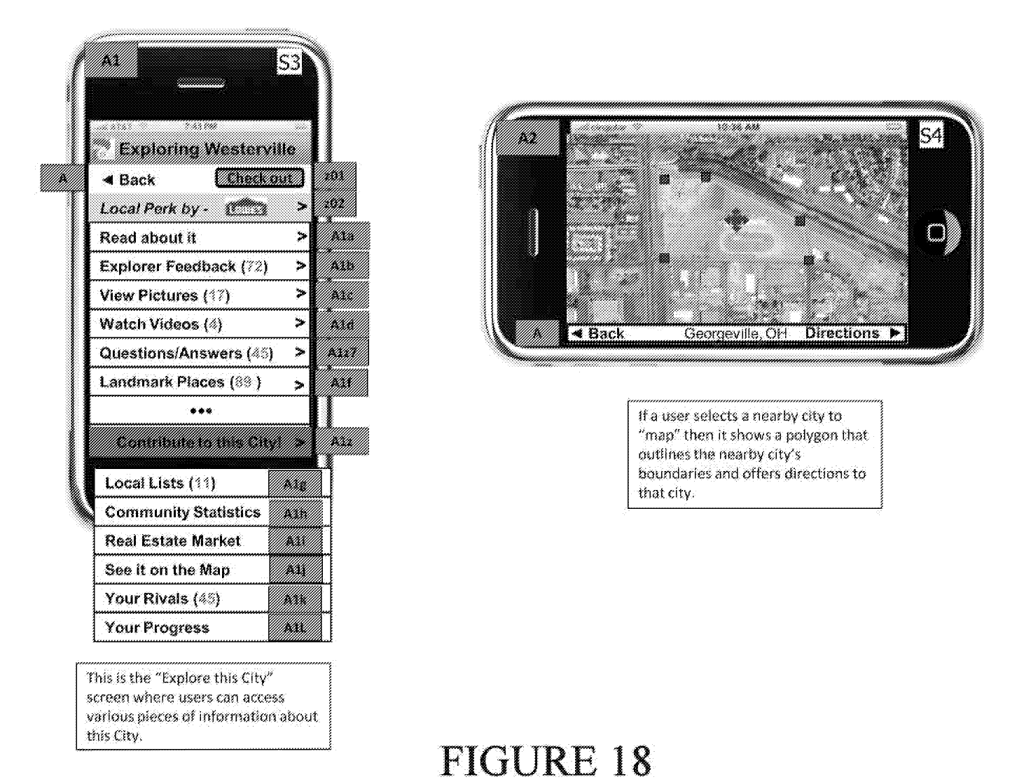

FIG. 18 is a drawing of a second set of output screens on a mobile device, according to an embodiment.

S3 represents an Exploring a City Screen. Once the user has selected to Explore a City, the user is giving a little to get a lot. The user is disclosing his or her “interest” in this city by checking into it. This means other users can see the user's profile when they look at who has checked in to the city recently. In exchange, the user gets all of this information about this city that cannot be found anywhere else conveniently on the user's phone or other portable device. This includes unique, ground-level and authentic information added by Explorers from their phones/mobile devices as well as from contributors on the home site of an associated web site. Users can also see rival explorers in the city and their level of activity in the city relative to the users. The user can use this information to gauge the interest of other Explorers in this city. The user is also able to earn points in the game by contributing information under the “Explorer Feedback” button.

S4 represents Other City/Town's Nearby to Explore. The user has selected a city that he or she could check in and it shows the city boundary with an option to get directions to it. Clicking on directions, takes the user to a screen with turn by turn directions provided by Google Maps.

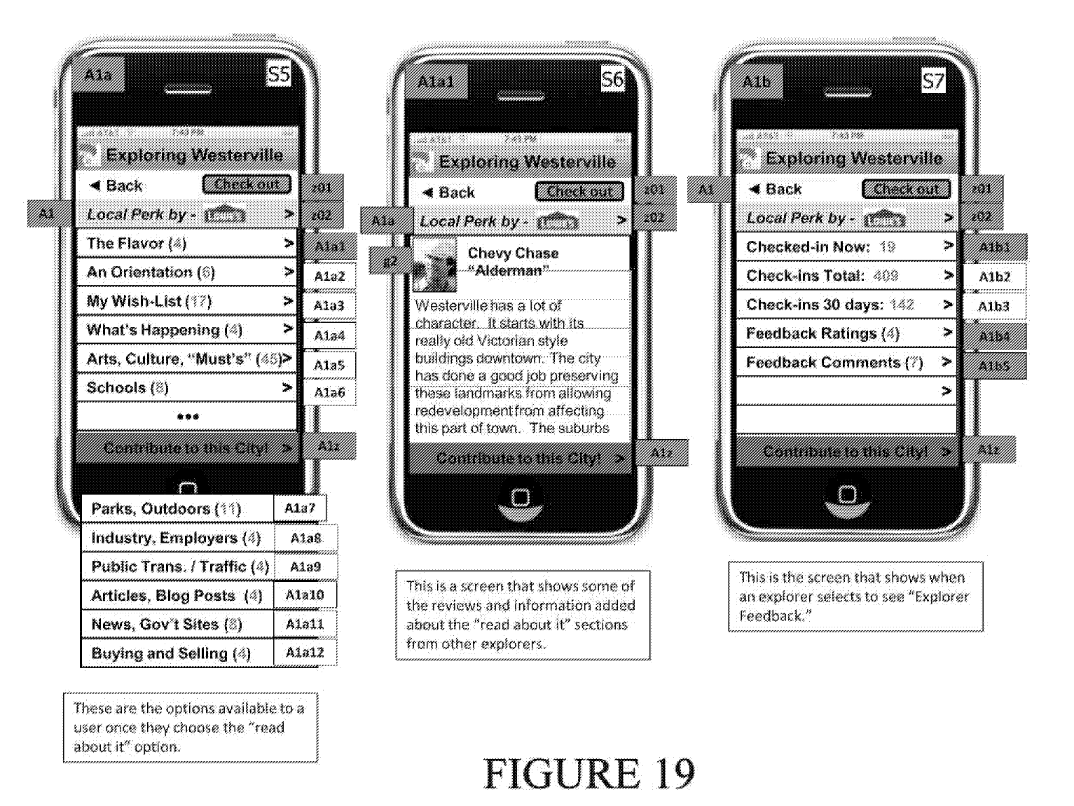

FIG. 19 is a drawing of a third set of output screens on a mobile device, according to an embodiment.

S5 represents Read About It, which shows the posts for each of the information sections on the associated web site for the section. The number represents how many posts can be read for each. If there are no posts in a particular topic, it doesn't show as option to click on.

S6 represents Read About It Posts, which shows the posts for each of the information sections on the associated web site for the section. The number represents how many posts can be read for each. If there are no posts in a particular topic, it doesn't show as option to click on. Clicking on an author's name shows their profile if they have a Place Explorer profile.

S7 represents Explorer Feedback, which shows information about other users (or explorers) currently checked in to this city right now and the history of all user activity. It also allows you to see the quantitative ratings of other explorers for this city as well as their feedback comments.

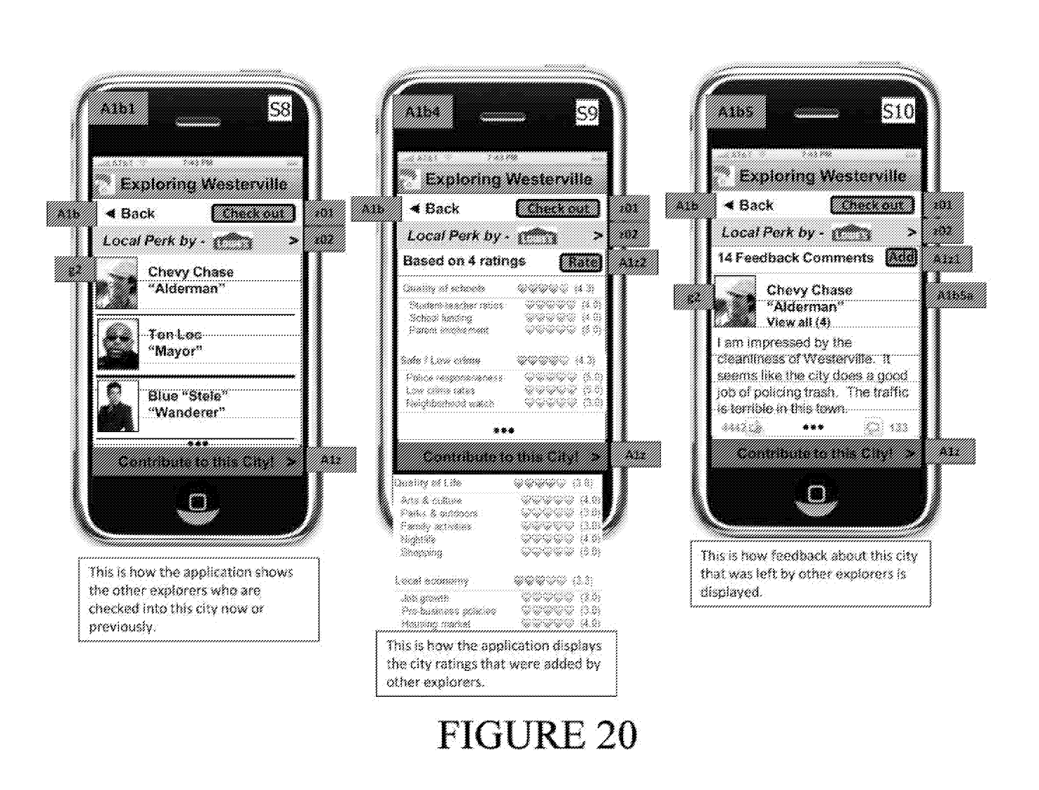

FIG. 20 is a drawing of a fourth set of output screens on a mobile device, according to an embodiment.

S8 represents Checked-in Now, which is how it looks when the user wants to see the other users who are checked in now or in the past. It shows the user's name and game Title that they have earned. Touching the user's picture shows me their profile.

S9 represents Feedback Ratings, which are the quantitative ratings that users can use to rate a city. These ratings are aggregated from user ratings on the phone and on the associated web site.

S10 represents Feedback Comments, which is how it looks when the user wants to read the feedback comments left by other users about this City. Clicking on “View All” shows all this user's comments for this city.

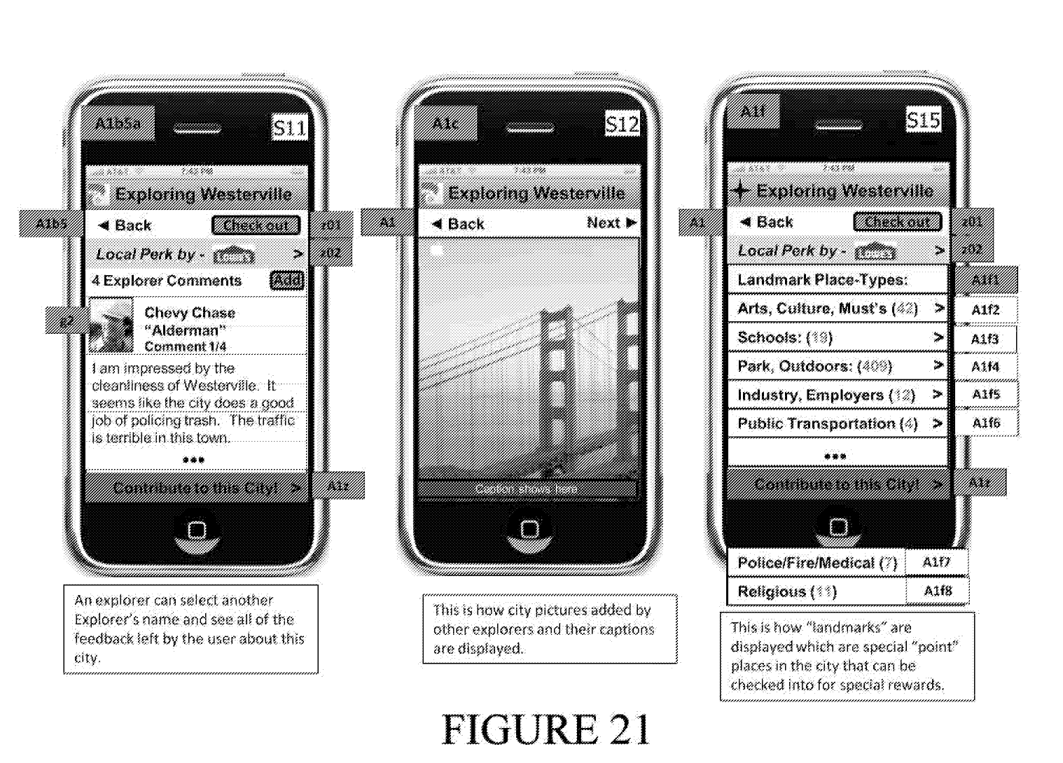

FIG. 21 is a drawing of a fifth set of output screens on a mobile device, according to an embodiment.

S11 represents All Feedback Comments by Explorer. After clicking on “View All” this shows all this user's comments for this city.

S12 represents View Pictures, which is what it looks like viewing the pictures of the city.

S13 represents Landmark Places. Landmark Places are individual places that can be explored and checked in to like schools, parks, and religious places. The “star” shows in place of the logo up top when the user is in the vicinity of a “Landmark Place” that the user can check into. Touching it takes the user to the screen to explore it. This star appears on any screen in place of the logo to alert the user that they are near something they can explore.

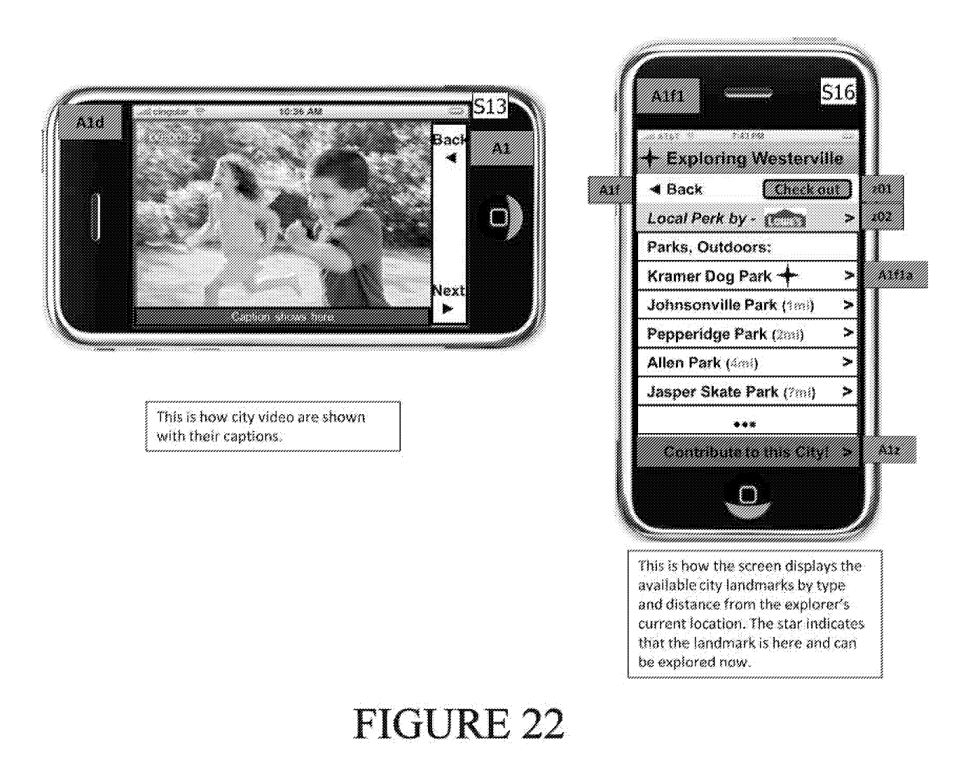

FIG. 22 is a drawing of a sixth set of output screens on a mobile device, according to an embodiment.

S13 represents Watch Videos, which allows the user to watch the city videos.

S16 represents Landmark Place-Types, which shows all the landmarks of this type in this city in order of closest to furthest to where the user is. The orange star indicates that the user is in the vicinity and can check into it now.

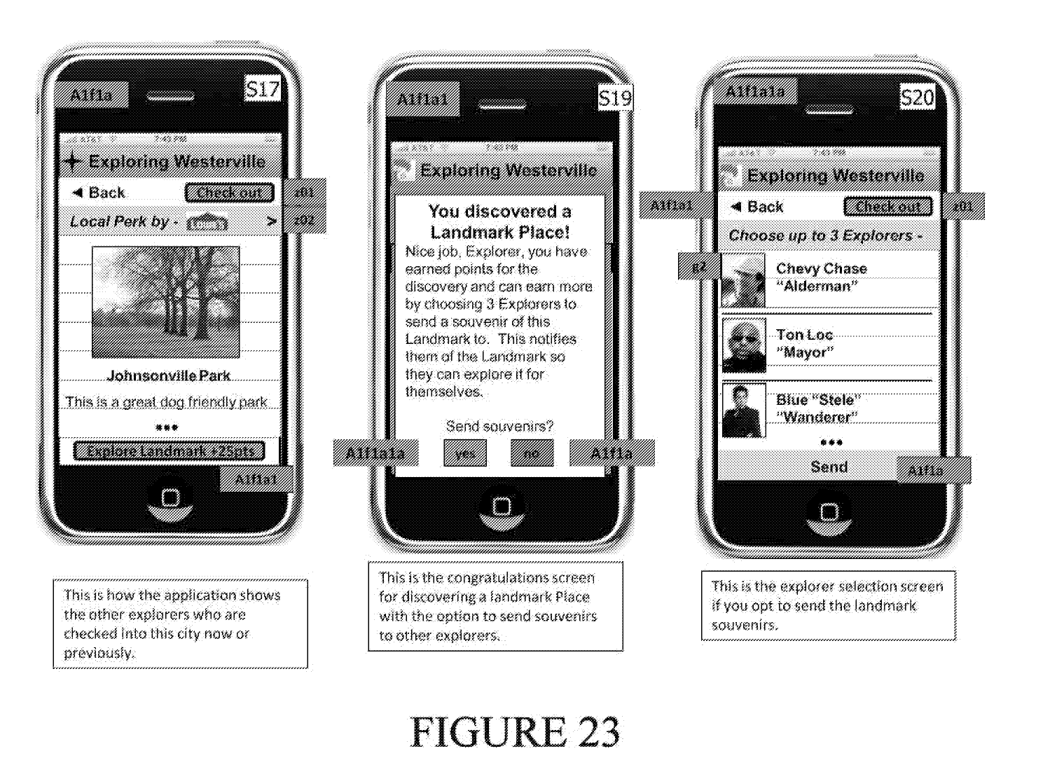

FIG. 23 is a drawing of a seventh set of output screens on a mobile device, according to an embodiment.

S17=Landmark Screen. This is what the screen looks like when the user is looking at a Landmark Place. If the user is at this location, then the user sees the “Explore Landmark” button at the bottom of the screen that gives the user points for exploration and takes the user to the Souvenir screen.

S19 represents Send a Souvenir. When the user explores a landmark, the user earns 3 “souvenirs’ that he or she can send to other users. This alerts them to the Landmark so they can explore it for themselves. It also grants both the sender and receivers bonus Souvenir points. This screen congratulates the user for discovering a Landmark Place and asks if the user would like to send up 3 souvenirs to fellow players (other users or other explorers).

S20 represents Send Souvenir Screen. This page lists the other users in order of most recent contact with the user first, then in order of most active in the same city. Touching an Explorer's picture highlights them in red and up to 3 can be selected.

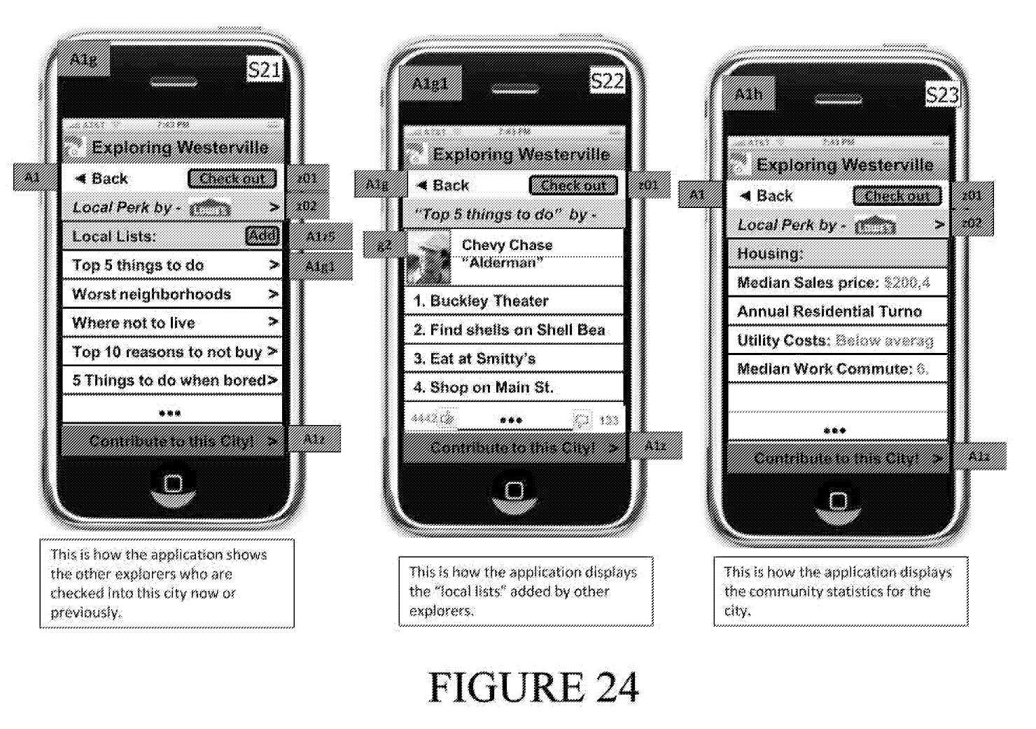

FIG. 24 is a drawing of an eighth set of output screens on a mobile device, according to an embodiment.

S21 represents Local Lists, which shows all the “Local Lists” added for this city.

S22 represents A Local List, which shows how a “Local List” is displayed that was added by a user.

S23 represents Community Statistics, which shows the community statistics listed on this page (based on the U.S. Census) from this City's associated web page.

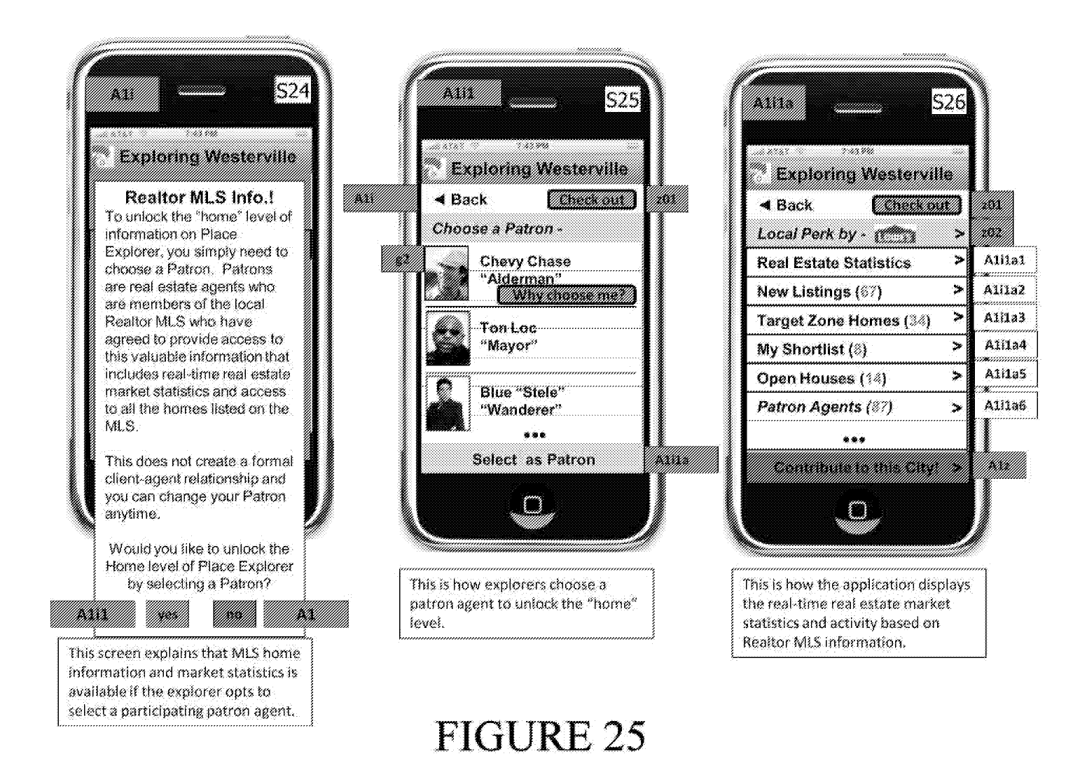

FIG. 25 is a drawing of a ninth set of output screens on a mobile device, according to an embodiment.

S24 represents Unlock Homes—This message shows when the user tries to go to this screen assuming the user has not selected a Patron Agent yet. This Real Estate Market information is fed by the Realtor MLS and is only accessible to users if they opt to choose a Real Estate Agent who has joined Place Explorer as a “Patron” which means users can access this information through association with a member of the Realtor MLS. Users do not see this screen if they have already selected a Patron.

S25 represents Choose a Patron Screen. Patrons are listed in order of most recently active first with the exception of those agents who have paid more for premium placement. One option agents can pay for allows them to add a “Why choose me” message that pops up when touched.

S26 represents Real Estate Market—Statistics. This shows statistical information based on real time MLS Data. New Listings—shows the homes listed on the MLS in the past 24 hours. Target Zone Homes—These are the homes that meet my Target Zone criteria on my profile. My Shortlist—These are the homes I have manually added to my list of favorites. Open Houses Shows the homes that have been indicated on the MLS to have an open house in the next 7 days. Patron Agents—shows the list of all the agents in play in this city.

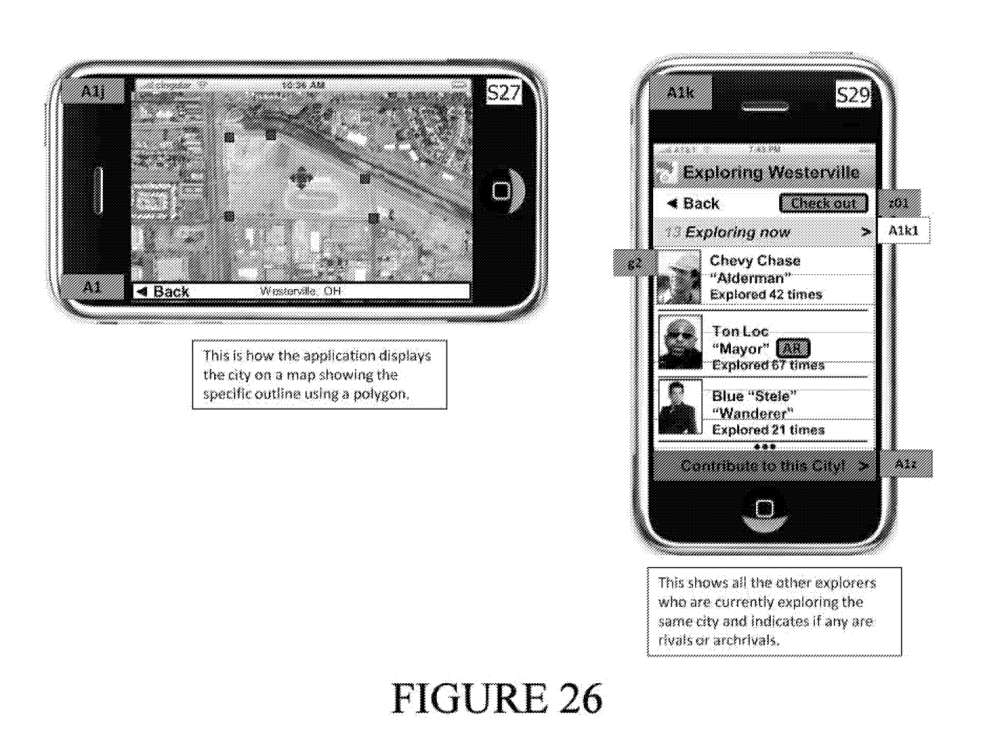

FIG. 26 is a drawing of a tenth set of output screens on a mobile device, according to an embodiment.

S27 represents See it on the Map. This screen shows this city's polygon on the map. These polygons are added, moderated and stored on the associated website.

S29 represents Your City Rivals. This shows the user's rival users in this city. AR indicates that they are an Archrival. Listed in order of most recently checked in to this city.

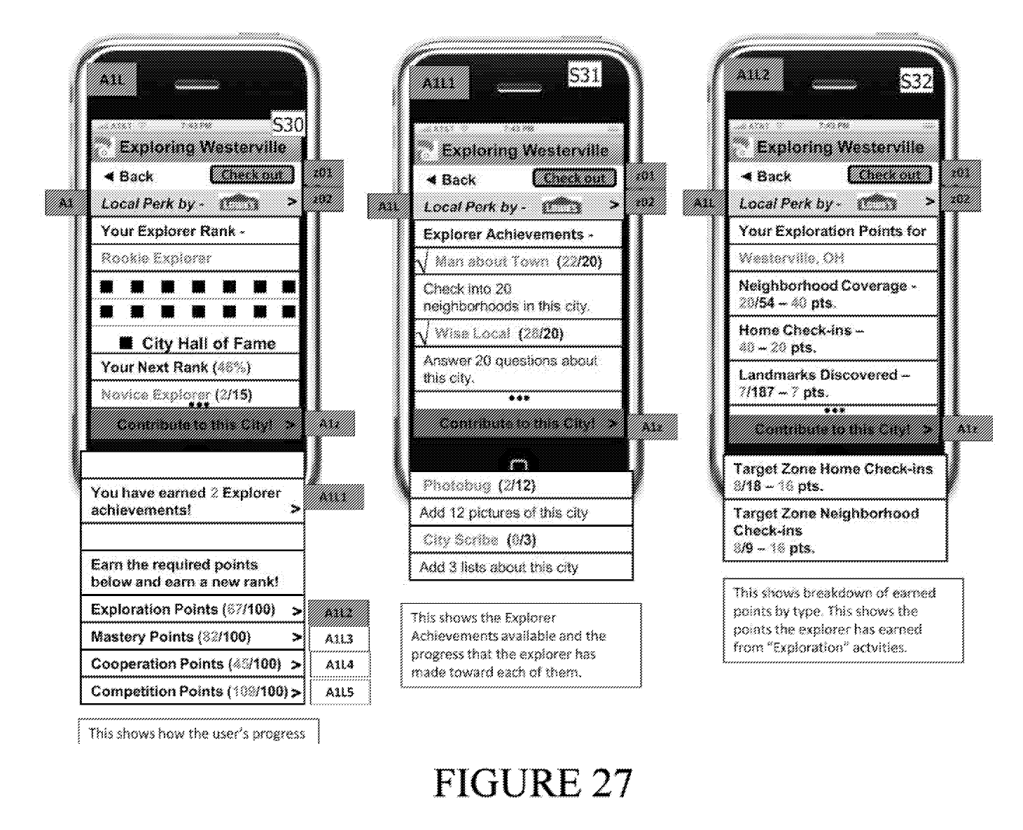

FIG. 27 is a drawing of an eleventh set of output screens on a mobile device, according to an embodiment.

S30 represents Your City Progress. This screen shows the user's current Place Explorer Rank as well as the next rank the user is working towards. It also shows what special achievements the user has earned. Next it shows the 4 Place Explorer activity types and the points earned in each. A new rank is earned once the new thresholds are met in all 4 areas. Clicking on one of the areas shows the activities that a user has done that has resulted in points. Explorer Ranks can be as follows: Rookie Explorer—Earned after checking into the game 4 times, Novice Explorer, Hobby Explorer, Wayfarer, Pioneer, Tracker, Point-man, Navigator, Scout, Pathfinder, Trailblazer, Expert Explorer, Master Explorer, Expedition Leader, Veteran Explorer (Awarded upon winning the game

S31 represents Explorer Achievements for this City. This shows the criteria for achievements that the user can earn in this city and what the user has accomplished.

S32 represents Your Exploration Points. This screen breaks down the game activities the user has done that have earned Exploration Points.

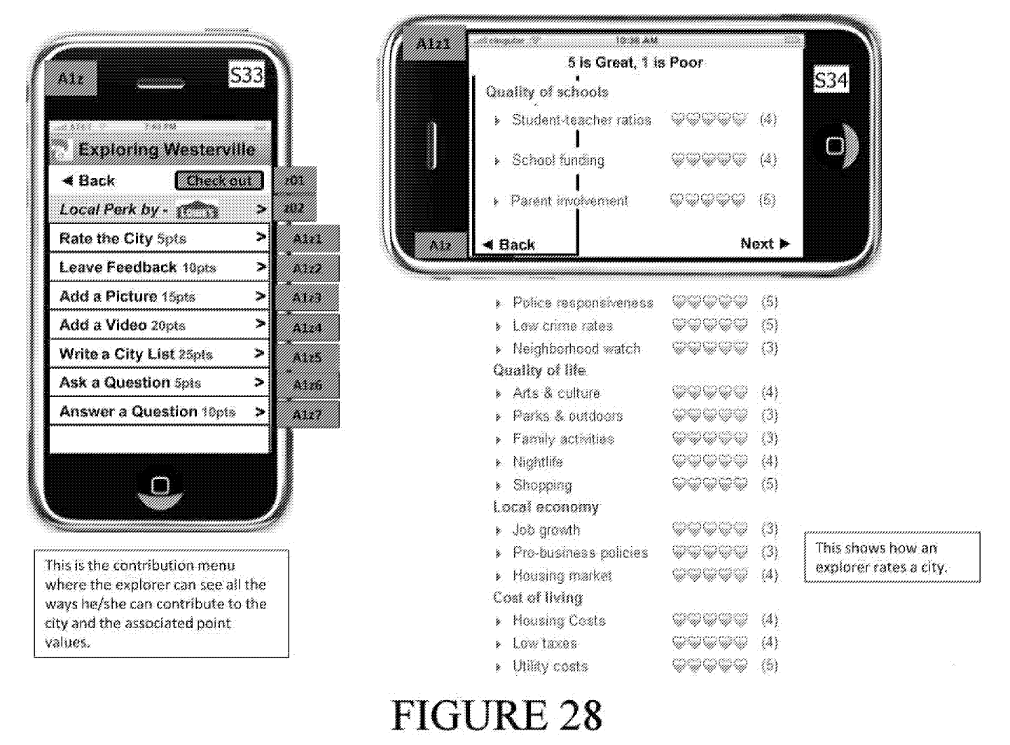

FIG. 28 is a drawing of a twelfth set of output screens on a mobile device, according to an embodiment.

S33 represents Contribute to the City. This is how it looks when the user is checked in to a city and clicks on the “contribute” bar. These are the ways a user can earn points by contributing.

S34 represents Rate the City. This is how it looks when a user wants to rate the city. It appears in landscape and the user presses the star to represent a rating and uses “next” to move through the rating categories. These ratings are synchronized with the same ratings for this city on the associated website.

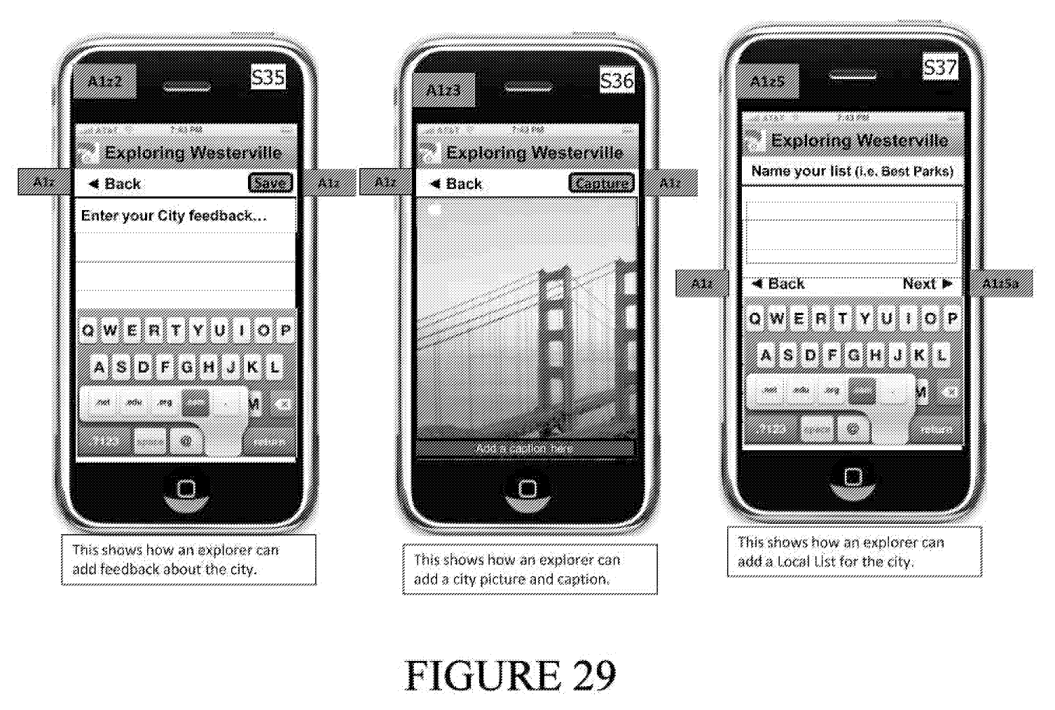

FIG. 29 is a drawing of a thirteenth set of output screens on a mobile device, according to an embodiment.

S35 represents Leave your City Feedback. This is how it looks when a user wants to write some feedback about the City they have explored. The default text disappears with the first character entered.

S36 represents Add a Picture. Users can use a standard cell-phone camera functionality to take a picture of the city and share it. It can also input a caption of no more than 50 characters.

S37 represents Write a City List. This is how users make a “Top 5” list of “best things to do” or “what I like most” etc.

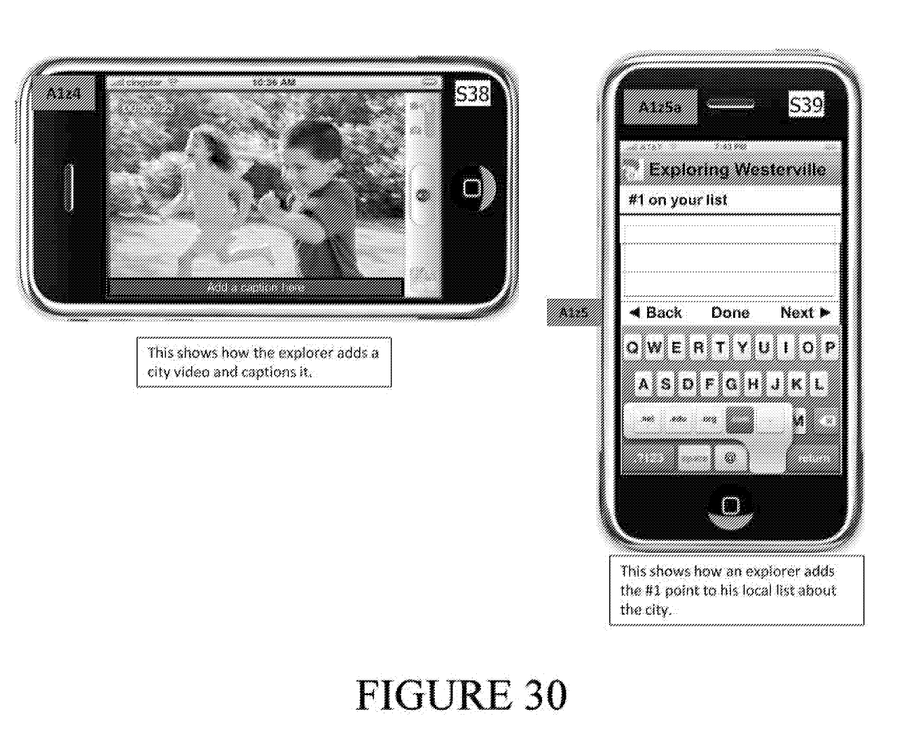

FIG. 30 is a drawing of a fourteenth set of output screens on a mobile device, according to an embodiment.

S38 represents Add a Video. Users can use the standard cell-phone video camera functionality to take a video of the city and share it. It can also input a caption of no more than 50 characters

S39 represents Write a City List. The user can simply maintain a list of points about the city.

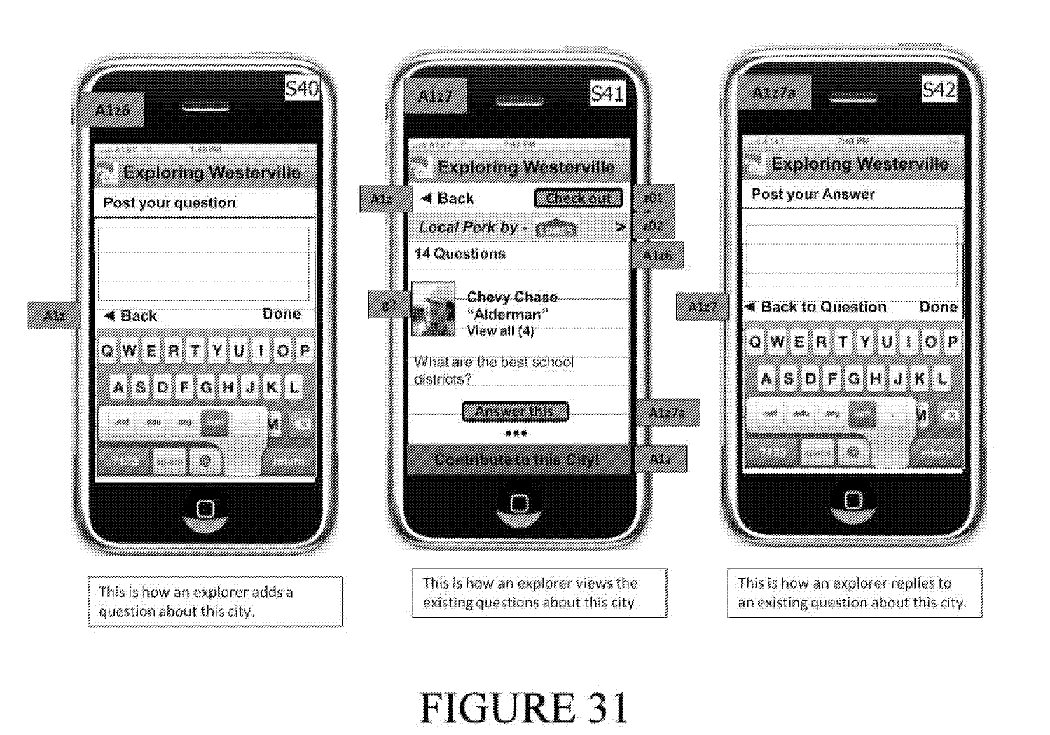

FIG. 31 is a drawing of a fifteenth set of output screens on a mobile device, according to an embodiment.

S40 represents Ask a Question. This posts a question to the other users who are exploring this city.

S41 represents View City Questions. This shows the questions asked about this city in order of most recent first.

S42 represents Answer a Question. This is where the user writes their answer to a question.

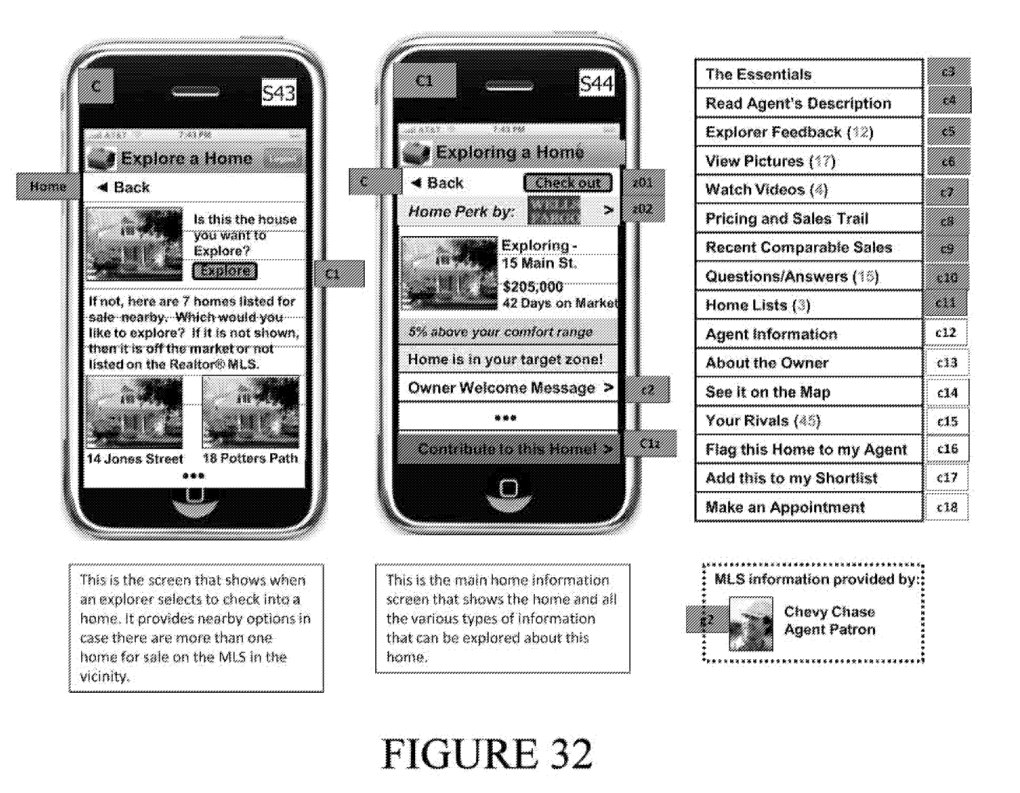

FIG. 32 is a drawing of a sixteenth set of output screens on a mobile device, according to an embodiment.

S43 represents Select a Home Screen. This screen confirms which home the user would like to explore by touching the picture and clicking “explore.” Doing so checks the user into the home and reveals a world of information about the home. The house icon shows when the user is in proximity to a house the user can check into.

S44 represents Exploring a Home. Once the user has selected to Explore a Home, the user is giving a little to get a lot. This is the information the user sees when the user “explores” a home. It will tell the user if the home is in your price comfort range or above it depending on what the user entered on his or her profile. It will also notify the user if the home is in the user's target zone which means it meets the home criteria the user saved to his or her profile. Lastly, it will notify the user if the home is in Foreclosure or a Bank-Owned Home.

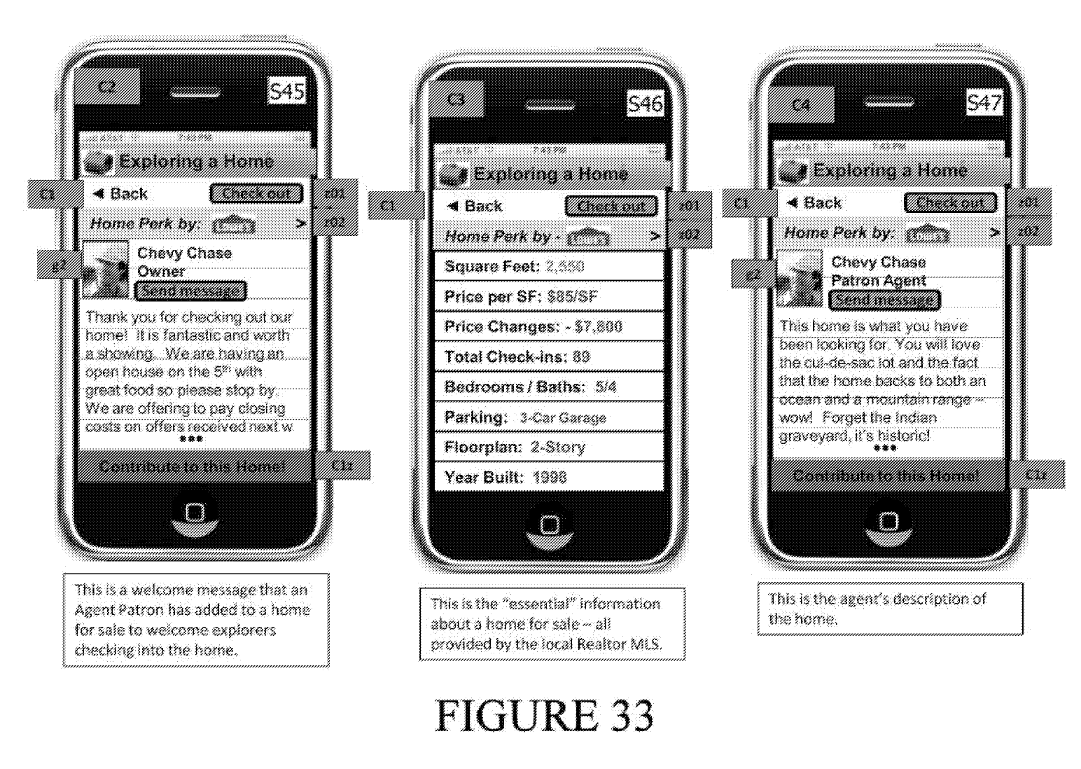

FIG. 33 is a drawing of a seventeenth set of output screens on a mobile device, according to an embodiment.

S45 represents Owner Welcome Message. This shows what it looks like if the owner has added a welcome message about his home. It can be added and updated by the home's owner if he is a player or the home's agent. They can use it to announce open houses, highlight something interesting about the house or offer incentives or perks like: Free gift for seeing home—Furniture, closing costs, quick close, etc.

S46 represents The Home Essentials. These are the most important data points about the house from the MLS.

S47 represents Agent Description. This is pulled over from the MLS description

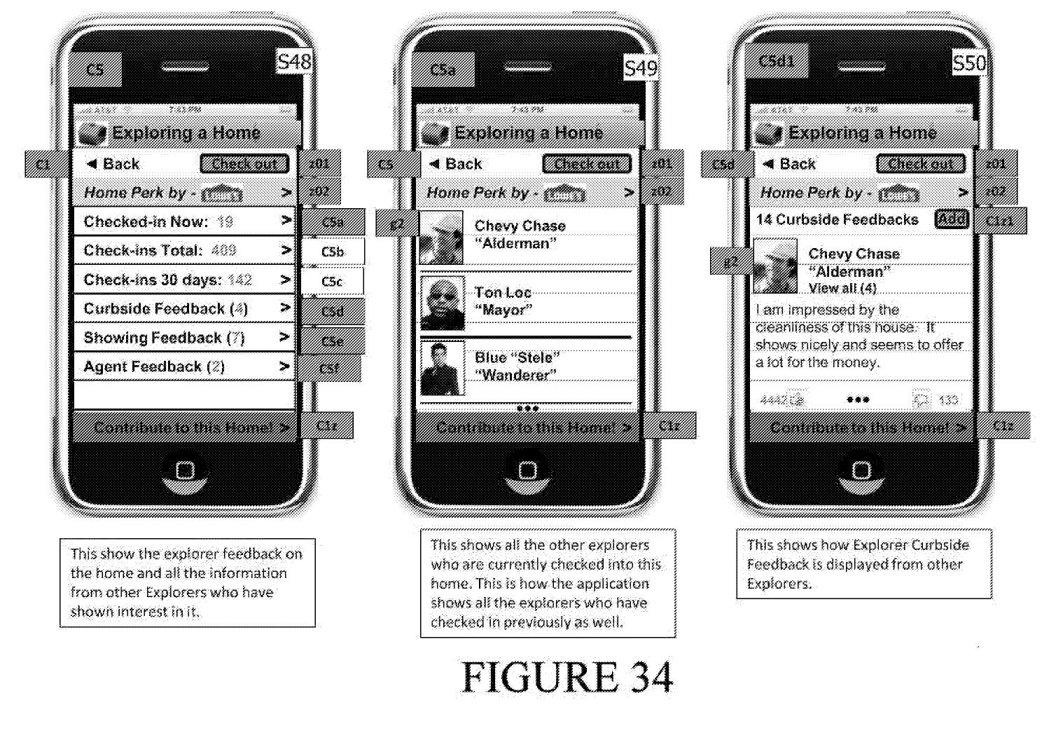

FIG. 34 is a drawing of an eighteenth set of output screens on a mobile device, according to an embodiment.

S48 represents Explorer Feedback on the Home. This shows information about other users currently checked in to this home right now and the history of all user activity. It also allows the user to see the quantitative ratings of other users for this home as well as their feedback comments.

S49 represents Checked-in Now. This is how it looks when the user wants to see the other users who are checked in now or in the past. It shows each user's name and game Title that they have earned. Touching each user's picture shows their profile.

S50 represents Curbside Feedback Comments. This is how it looks when the user wants to read the curbside feedback comments left by other users about this Home. Clicking on “View All” shows all this user's comments for this home. The owner/agent is notified of each comment and has the ability to respond to each comment that is showed right beneath the comment.

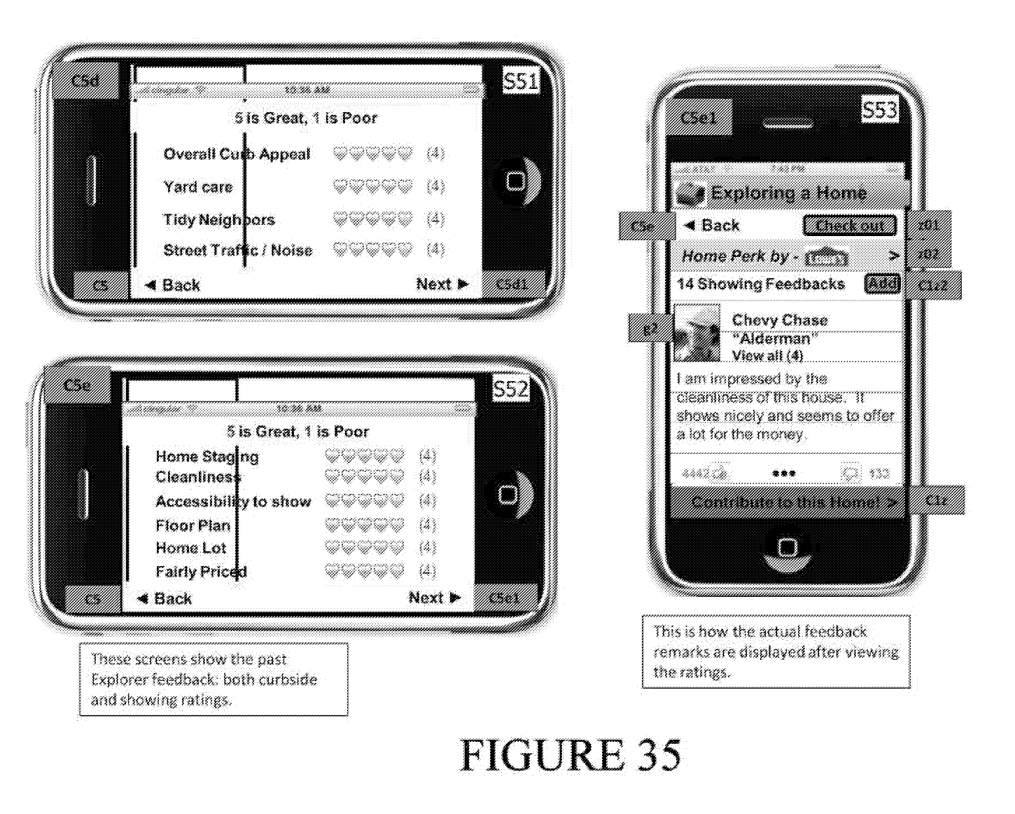

FIG. 35 is a drawing of a nineteenth set of output screens on a mobile device, according to an embodiment.

S51 represents View Curbside Feedback. This is the first part of curbside feedback on this house.

S52 represents View Showing Feedback This is the first part of showing feedback on this house.

S53 represents Showing Feedback Comments—This is how it looks when the user wants to read the showing feedback comments left by other users about this home (the home checked in to). Clicking on “View All” shows all of the user's comments for this home. The owner/agent is notified of each comment and has the ability to respond to each comment that is showed right beneath the comment.

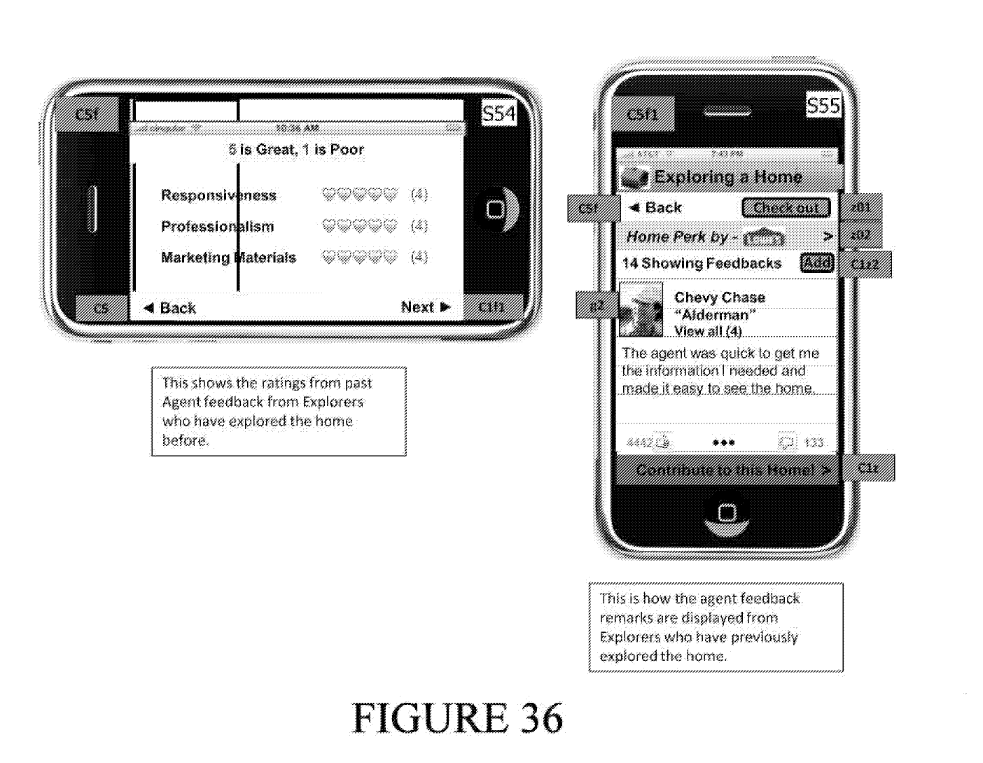

FIG. 36 is a drawing of a twentieth set of output screens on a mobile device, according to an embodiment.

S54 represents Seller's Agent Feedback. This is the first part of viewing the feedback about the seller's agent.

S55 represents Agent Feedback Comments—This is how it looks when the user wants to read the agent feedback comments left by other users about this Home. Clicking on “View All” shows all of the user's comments for this home. The owner/agent is notified of each comment and has the ability to respond to each comment that is showed right beneath the comment.

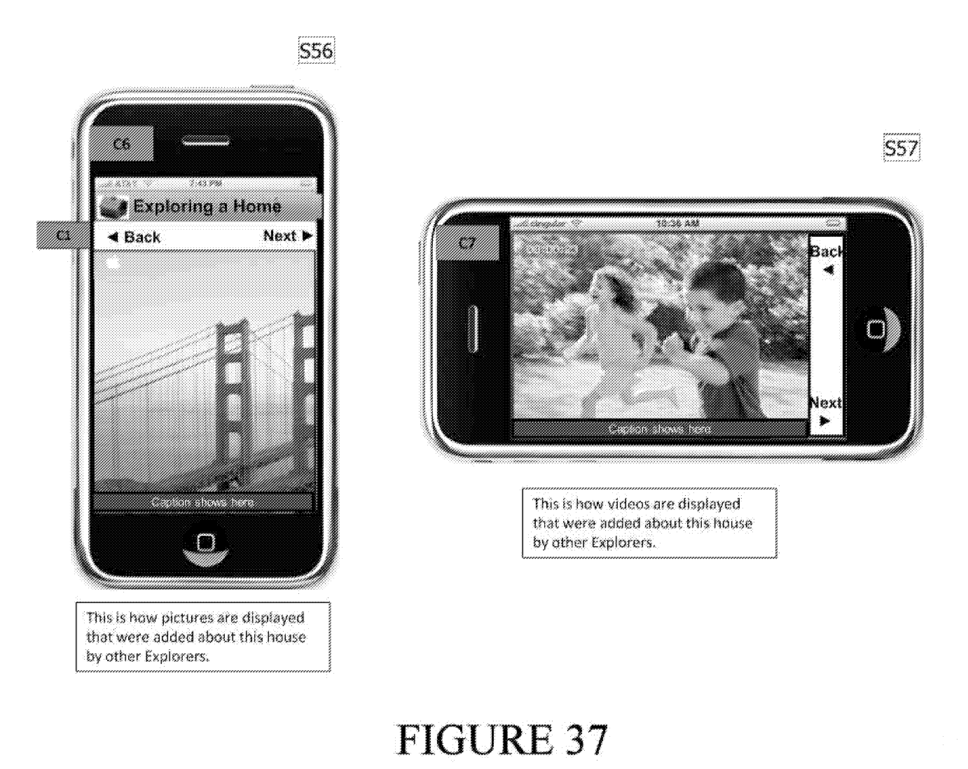

FIG. 37 is a drawing of a twenty-first set of output screens on a mobile device, according to an embodiment.

S56 represents View Pictures. This allows the user to view pictures of the home.

S57 represents Watch Videos. This allows the user to watch videos of the home.

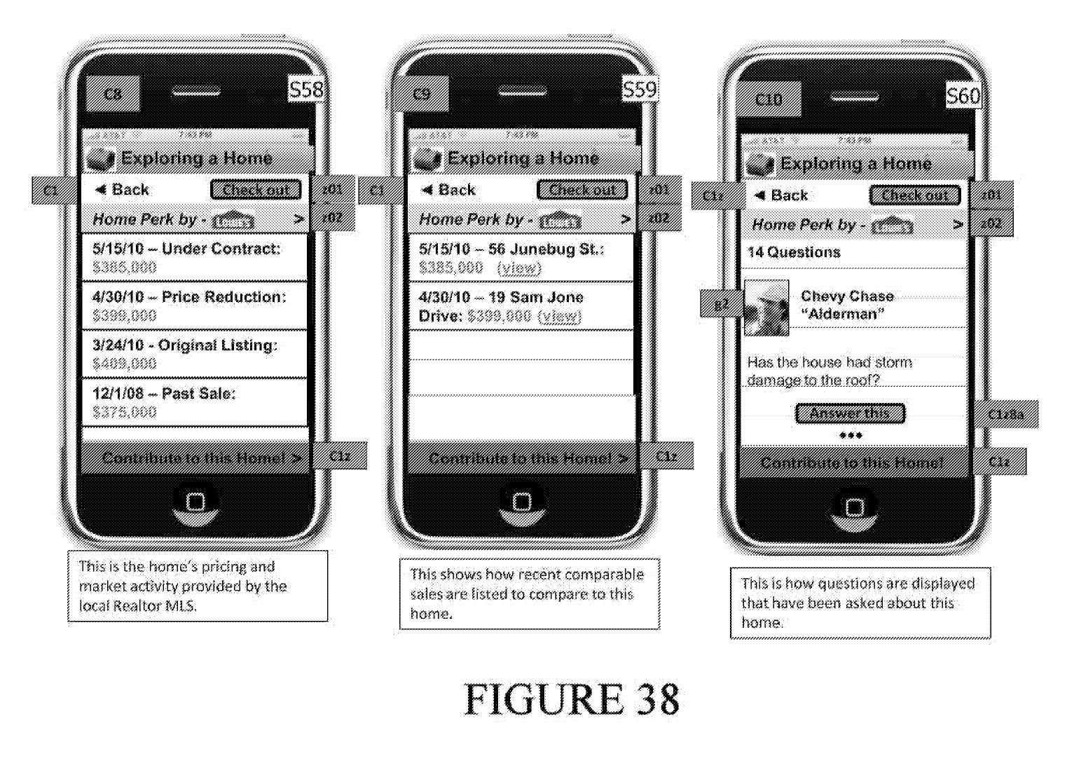

FIG. 38 is a drawing of a twenty-second set of output screens on a mobile device, according to an embodiment.

S58 represents Pricing and Sales Trail. This shows information pulled from the Realtor MLS about the home's pricing and sales history.

S59 represents Recent Comparable Sales. This uses a formula to pull comparable sales from the MLS in the past 6 months. Clicking on “view” shows that home's “essential” information

S60 represents View House Questions. This shows the questions asked about this house in order of most recent first.

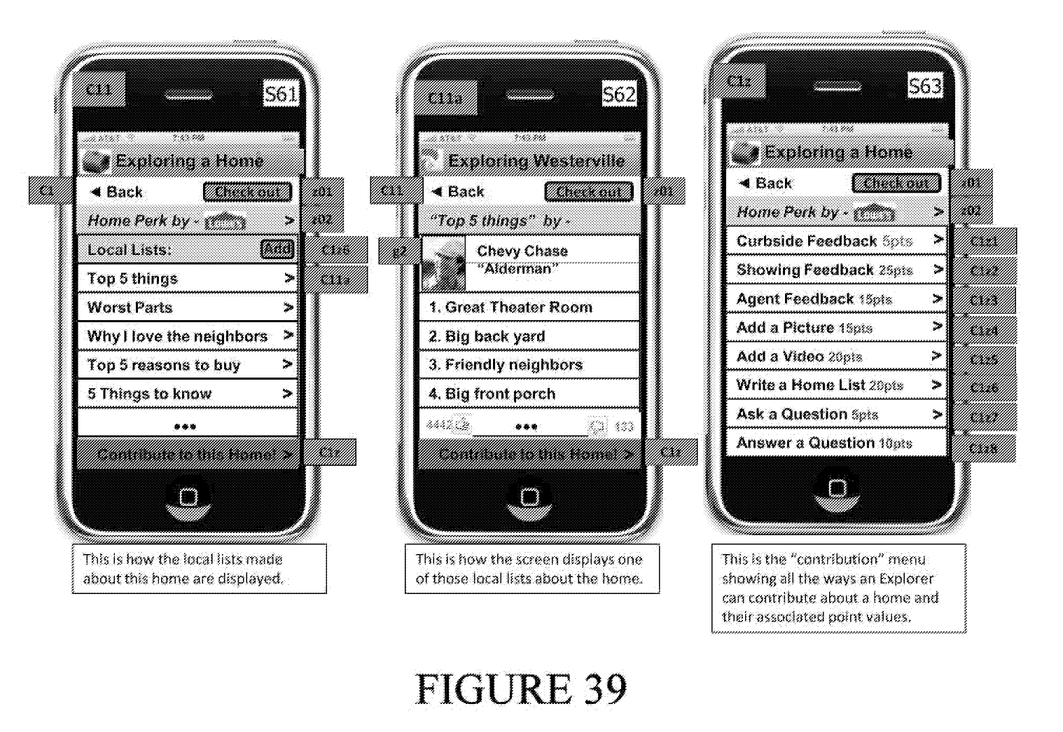

FIG. 39 is a drawing of a twenty-third set of output screens on a mobile device, according to an embodiment.

S61 represents Home Lists. This shows all the “Home Lists” added for this home.

S62 represents A Home List. This screen shows how a “Home List” is displayed that was added by a user.

S63 represents Contribute to the Home. This is how it looks when the user is checked in to a home and clicks on the “contribute” bar. These are the ways a user can earn points by contributing.

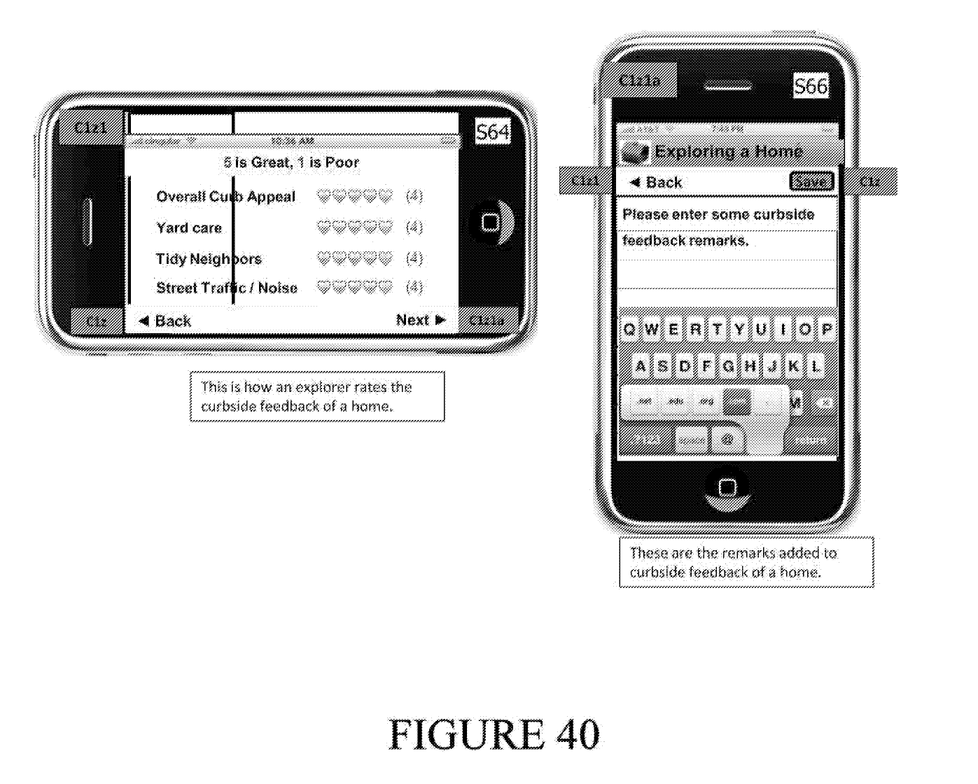

FIG. 40 is a drawing of a twenty-fourth set of output screens on a mobile device, according to an embodiment.

S64 represents Curbside Feedback. Leaving curbside feedback begins with some quantitative ratings and the next step is to leave feedback remarks.

S66 represents Curbside Feedback part 2. This is the second part of leaving curbside feedback, comprising the write up.

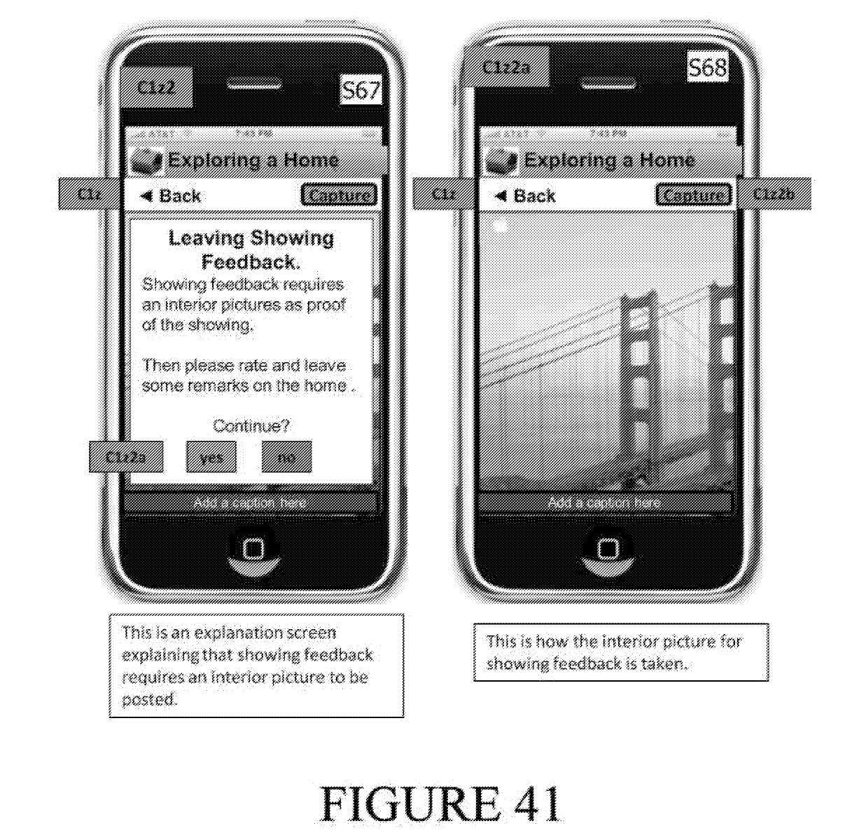

FIG. 41 is a drawing of a twenty-fifth set of output screens on a mobile device, according to an embodiment.

S67 represents Showing Feedback Confirmation. This message explains that showing feedback requires an interior photo.

S68 represents Showing Feedback. The first step of showing feedback is to take an interior photo. It adds to the feedback and also proves that the user was in the home.

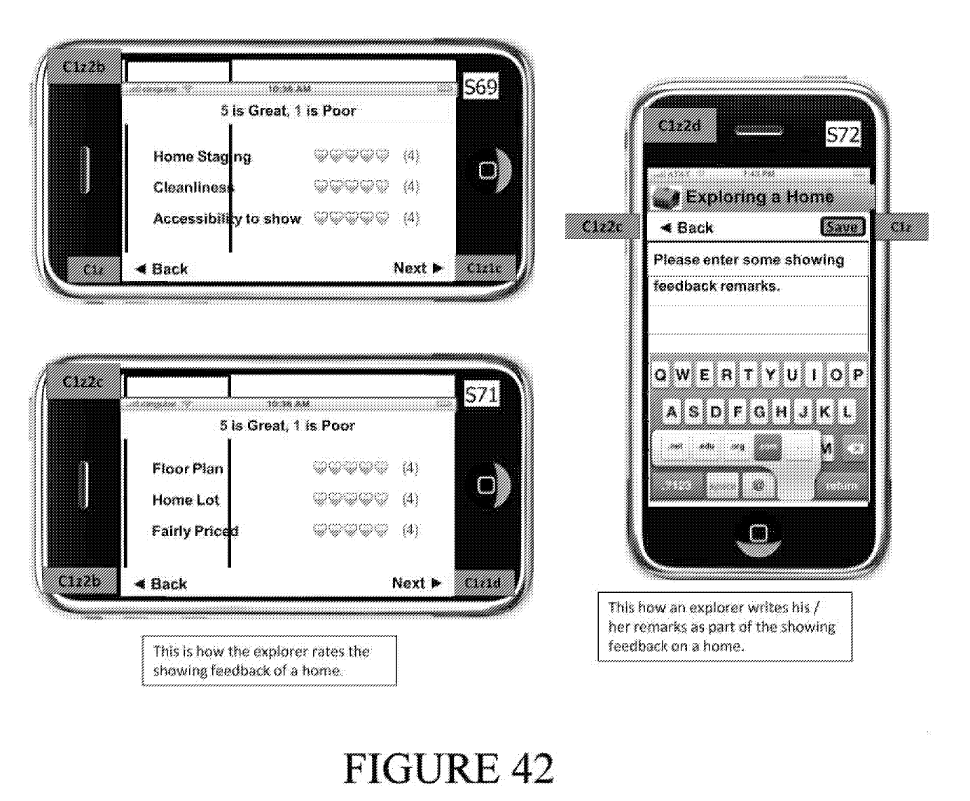

FIG. 42 is a drawing of a twenty-sixth set of output screens on a mobile device, according to an embodiment.

S69 represents Showing Feedback Ratings. Next is rating some aspects of the home.

S71 represents Showing Feedback Ratings. Next is rating further aspects of the home.

S72 represents Showing Feedback Remarks. This completes the showing feedback.

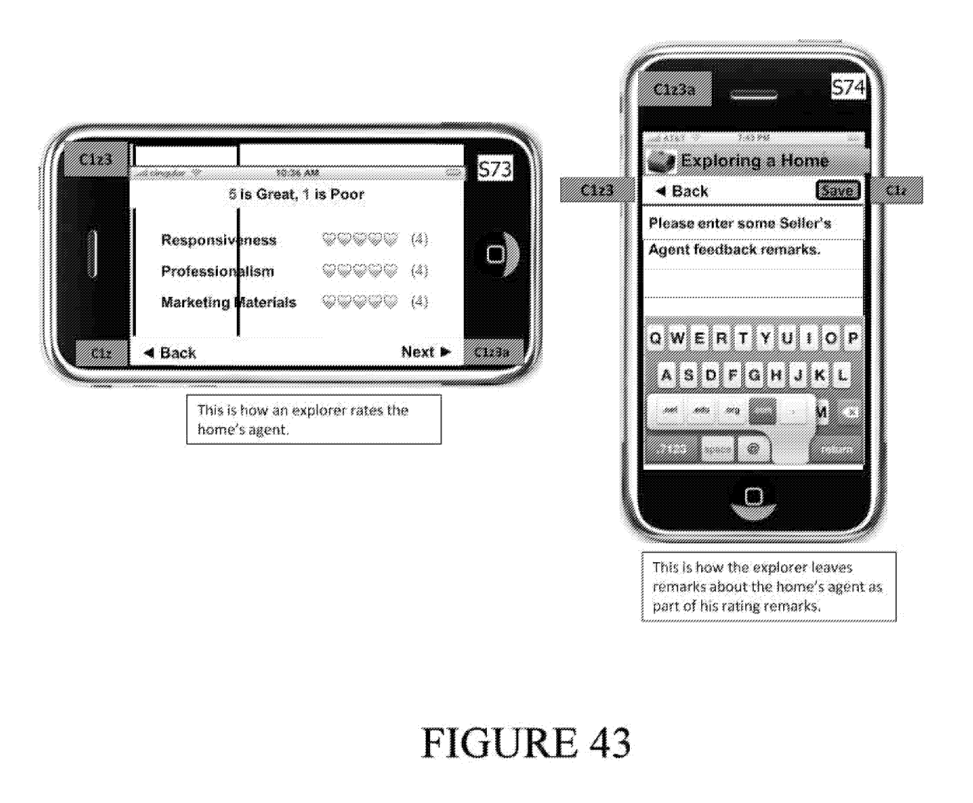

FIG. 43 is a drawing of a twenty-seventh set of output screens on a mobile device, according to an embodiment.

S73 represents Seller's Agent Feedback. This allows the user to leave feedback on the agent, which starts with some ratings.

S74 represents Agent Feedback Remarks. This completes the agent feedback.

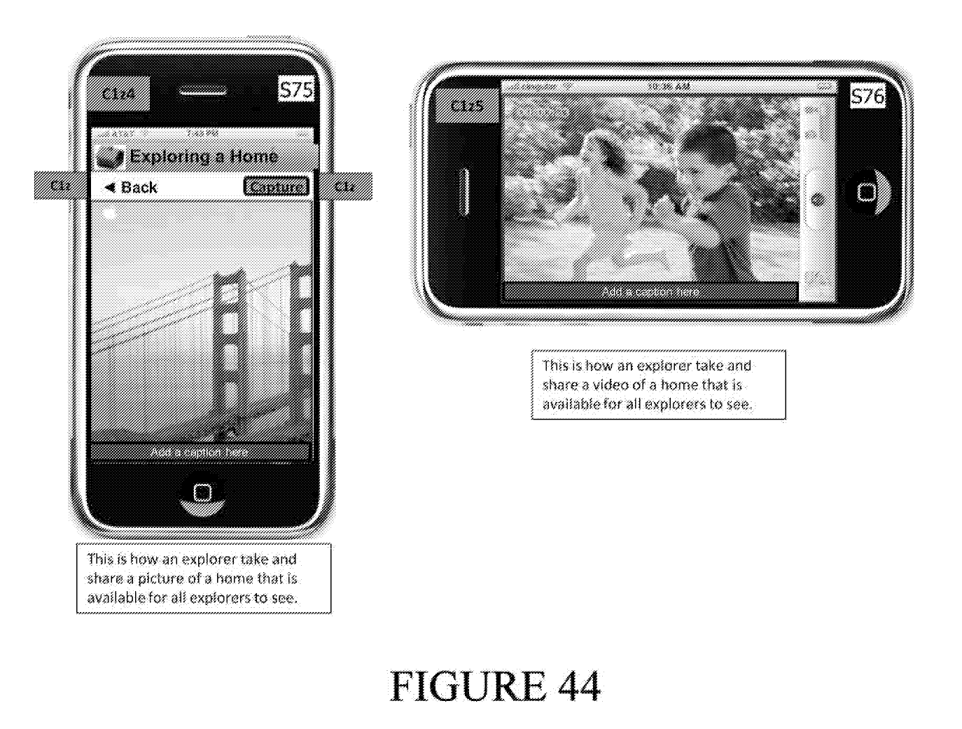

FIG. 44 is a drawing of a twenty-eighth set of output screens on a mobile device, according to an embodiment.

S75 represents Add a Picture. Users can use their standard cell-phone camera functionality to take a picture of the house and share it. It can input a caption of no more than 50 characters.

S76 represents Add a Video. Users can use their standard cell-phone video camera functionality to add a video.

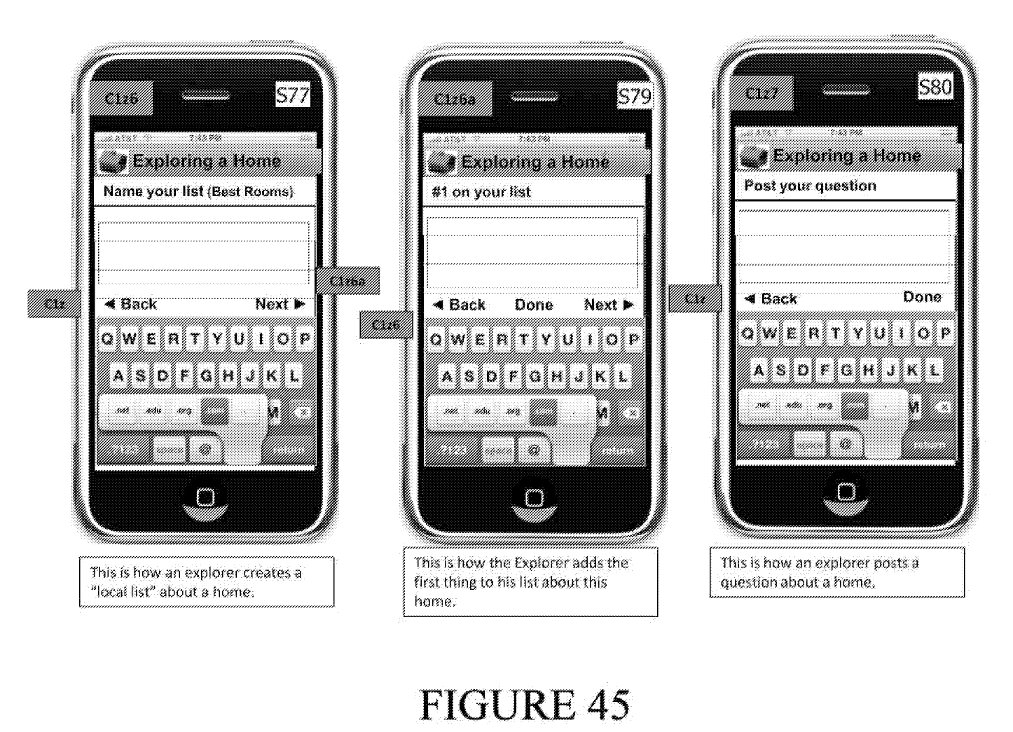

FIG. 45 is a drawing of a twenty-ninth set of output screens on a mobile device, according to an embodiment.

S77 represents Write a House List. This is how users can make a “Top 5” list of “best rooms in the house” or “what I like most” etc.

S79 represents Write a City List. The user can make a list of things about the home.

S80 represents Ask a Question. This posts a question to the other users who are exploring this home as well as the home owner and agent who will get alerted to any questions asked about the home.

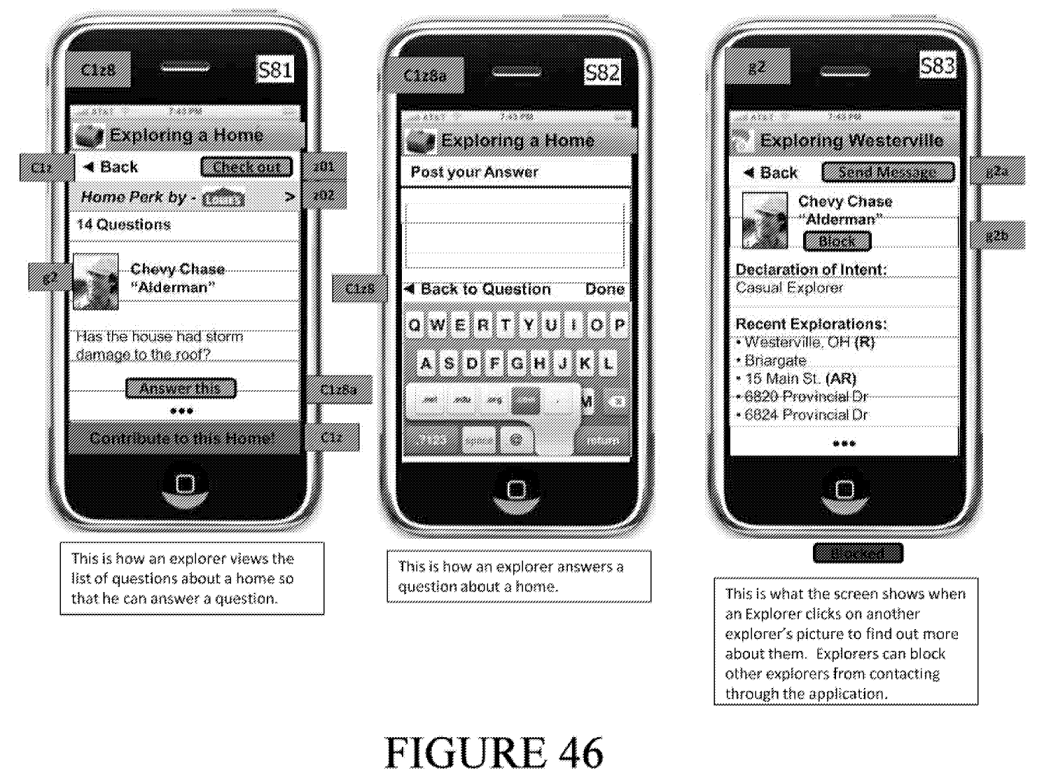

FIG. 46 is a drawing of a thirtieth set of output screens on a mobile device, according to an embodiment.

S81 represents View House Questions. This shows the questions asked about this house in order of most recent first.

S82 represents Answer a Question. This is where a user writes their answer to a question.

S83 represents Viewing Another Explorer's Profile. When the user clicks on another user's name or picture, the user is taken to a screen that shows a little information about them. It shows the user's recent check-ins in order of most recent first, and indicates with an “R” or “AR” if they are a rival or archrival with the user for any of the Places they have mutually explored with the user. The user would not see the “Send Message” button if this particular user has blocked you. The “blocked” image below shows instead of the “Block” button if the user has blocked this particular user from sending you message. Also shown are any achievements that this user has earned on their profile.

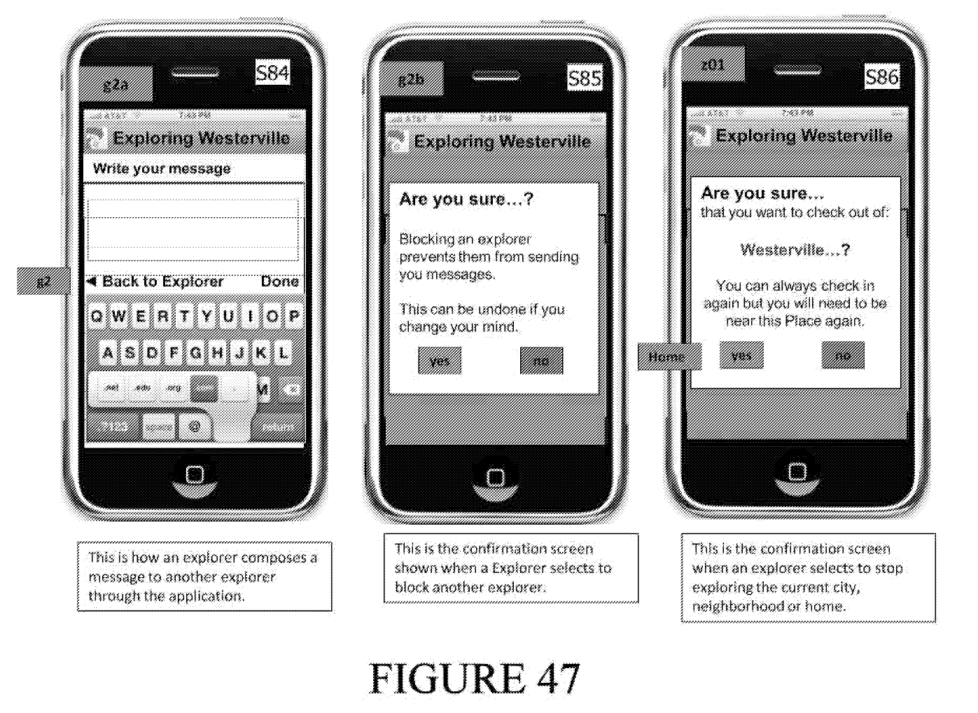

FIG. 47 is a drawing of a thirty-first set of output screens on a mobile device, according to an embodiment.

S84 represents Write a Message. This screen is how the user can send a message to another user.

S85 represents Block Explorer Confirmation. This is the screen that shows when the user click on “block” to block another user from messaging him or her.

S86 represents Check out Confirmation. This is the screen that shows when the user clicks on “check out.” Confirming returns the user to the Home Screen.

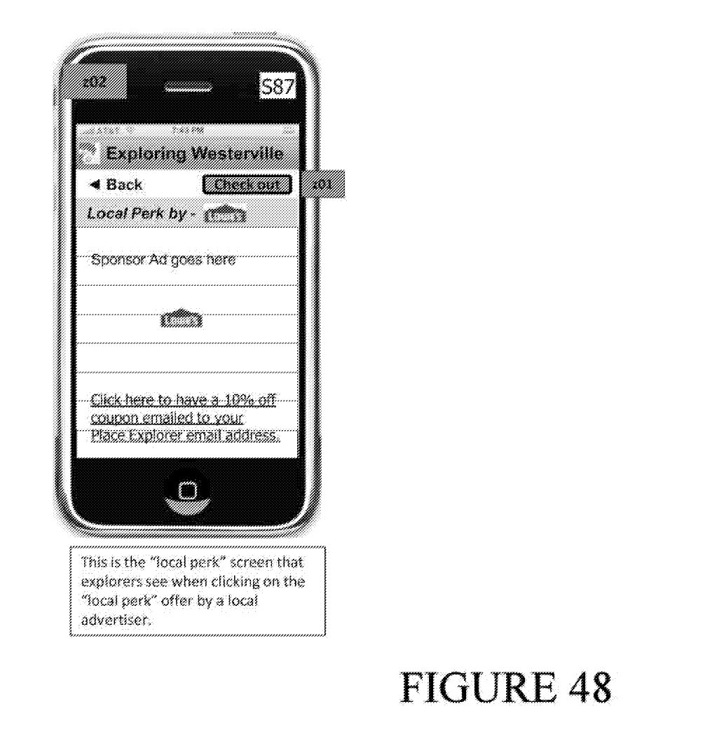

FIG. 48 is a drawing of a thirty-second set of output screens on a mobile device, according to an embodiment.

S87 represents Local Perk. This is the screen that shows when the user clicks on the “Local Perk” button. This is the advertisement that advertisers buy that shows here as well as on this Place's City Page on the associated website.

The associated web site is a web site that is hosted by a server that stores all of the “secondary market” information described herein (information about players, realtors, their communications, rankings, reviews, etc.) When a player is using his or her mobile communication device this information is accessible as described herein. Players can also access this information using their home computer by logging into the associated web site which can then serve (using a server connected to the database) the information to the player's home computer for display.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for sharing real estate information, the method comprising:
executing instructions on a processor running on a portable computing device to perform the following operations:
registering a first player in a remote database;
physically visiting a house by the first player;
checking in to the house by the first player; and
determining and displaying to the player a list of rivals, the list comprising other players that have checked in to the house at least once.

2. The method as recited in claim 1, wherein the displayed list of rivals is sorted in an order of determined interest, the determined interest based on factors comprising a number of times a rival has checked in to the house and activity by the rival for the house.

3. The method as recited in claim 2, wherein activity for the house comprising posting messages about the house.

4. The method as recited in claim 1, wherein a player on the list with a highest number of checked in homes in the ranking is given an award.

5. The method as recited in claim 1, further comprising determining an arch-rival(s) for the first player out of the rivals by comparing home preferences entered by the first player with home preferences entered by the rivals.

6. The method as recited in claim 1, wherein an arch-rival is one of the rivals whose home preferences are most similar to the first payer.

7. The method as recited in claim 1, further comprising awarding points to the first player when the first player checks into other homes and contributes content, and awarding a game award to the first player based on a number of points the first player has compared to points of rivals.

8. The method as recited in claim 1, further comprising awarding a game award the first player when the first player checks into at least a predetermined percentage of homes in a neighborhood.

9. A method for sharing real estate information, the method comprising:
registering a player in a remote electronic database;
registering an agent in the remote electronic database;
receiving a choice from the player to select the agent as the player's patron;
transmitting a request from the player to the agent for information about a particular home for sale;
querying, by the agent, a real estate database about the particular home for sale and receiving from the real estate database propriety information about the home for sale; and
transmitting, by the agent, the proprietary information to the player,
wherein only realtors registered with the real estate database can receive information from the real estate database,
wherein the player has no formal commitment with the agent and is not a realtor.

10. The method as recited in claim 9, wherein the real estate database is the Multiple Listing Service (MLS).

11. The method as recited in claim 9, wherein the player is anonymous to the agent.

12. The method s recited in claim 9, wherein the player does not have to provide their real full name to the agent and contact between the player and the agent is accomplished using a game name.

13. The method as recited in claim 12, wherein the player can choose to reveal their real full name and private contact information to the agent.

14. The method as recited in claim 9, wherein the agent is not anonymous to the player.

15. The method as recited in claim 9, wherein the transmitting from and to the player is performed on the player's mobile communication device.

16. The method as recited in claim 9, wherein the player does not have to make a commitment with the agent outside of the game.

17. A method for sharing real estate information, the method comprising:
registering a player in a remote electronic database;
physically visiting a home by the player;
checking into the home by the player using a mobile communication device; and
once the player has checked in to the home, allowing the player to view comments left by other players who have physically visited the home and checked in to the home, wherein if the player has not checked in to the home then the player Is not allowed to view the comments.

18. The method as recited in claim 17, further comprising receiving a comment from the player using the player's mobile communication device and displaying the comment from the player to other players who physically visit the home and check into the home.

19. The method as recited in claim 17, wherein allowing the player to take a photograph using the player's mobile communication device and displaying the photograph to other players who physically visit the home and check into the home.

20. The method as recited in claim 17, further comprising:
receiving a question from the player about the home;
forwarding the question to an associated realtor associated with a sale of the home;
receiving a response from the associated realtor; and
forwarding the response to the player.

21. The method as recited in claim 17, further comprising displaying to the player on the player's mobile communication device a number of other players currently checked into the home.

22. The method as recited in claim 17, further comprising displaying to the player on the player's mobile communicate device a number of other players that have ever checked in to the home.

23. The method as recited in claim 17, further comprising receiving a choice from the player to select the agent as the player's patron; and notifying the agent that the player has checked in to the home.

24. The method as recited in claim 17, further comprising determining a winning player based on a number of points earned by each player based on in-game activities.

25. The method as recited in claim 24, wherein in-game activities that earn points comprise checking in to homes and leaving comments.

26. The method as recited in claim 17, further comprising tabulating check-in data for all players to determine and display a list of homes and their relative interest.

27. The method as recited in claim 17, further comprising tabulating check-in data for all players to determine and display a list of neighborhoods and their relative interest.

28. The method as recited in claim 17, further comprising automatically notifying an agent selected by the player that the player has selected the home as a favorite home of the player.

29. The method as recited in claim 17, further comprising automatically notifying an agent selected by the player that the player has left a comment about the home.

30. The method as recited in claim 24, wherein the winning player is a winner for a particular city.
